(19) United States
(12) Patent Application Publication
(10) Pub. No.: US 2023/0333349 A1
(43) Pub. Date: Oct. 19, 2023

(54) OPTICAL LENS ASSEMBLY AND ELECTRONIC DEVICE

(71) Applicant: Ningbo Sunny Automotive Optech Co., Ltd., Ningbo City (CN)

(72) Inventors: Zhe Zhao, Ningbo City (CN); Yue Song, Ningbo City (CN); Dongfang Wang, Ningbo City (CN); Bo Yao, Ningbo City (CN)

(21) Appl. No.: 18/196,822

(22) Filed: May 12, 2023

Related U.S. Application Data
(63) Continuation of application No. PCT/CN2021/130629, filed on Nov. 15, 2021.

(30) Foreign Application Priority Data
Nov. 13, 2020 (CN) 202011268322.6
Mar. 12, 2021 (CN) 202110270238.6

(51) Int. Cl. G02B 13/00; G02B 9/62

(52) U.S. Cl. CPC G02B 13/0045; G02B 9/62

(57) ABSTRACT

Disclosed by the present application are an optical lens and an electronic device comprising the optical lens. The optical lens comprises in succession from an object side to an image side along an optical axis: a first lens provided with a negative focal power, the image side surface of which is concave; a second lens provided with a focal power, the object side surface of which is concave and the image side surface of which is convex; a third lens provided with a positive focal power, the object side surface of which is convex and the image side surface of which is convex; a fourth lens provided with a focal power, the object side surface of which is convex; a fifth lens provided with a focal power, the image side surface of which is convex; and a sixth lens provided with a focal power.

### CROSS-REFERENCE

This patent application is a continuation of International Application No. PCT/CN2021/130629, filed on Nov. 15, 2021, which claims the priority and benefit of Chinese Patent Application No. 202011268322.6 filed with the China National Intellectual Property Administration (CNIPA) on Nov. 13, 2020, and the priority and benefit of Chinese Patent Application No. 202110270238.6 filed with the China National Intellectual Property Administration on Mar. 12, 2021. All of the aforementioned applications are hereby incorporated by reference in their entireties.

### TECHNICAL FIELD

The present disclosure relates to the field of optical element, and more specifically to an optical lens assembly and an electronic device.

### BACKGROUND

With the development of autonomous driving technology, vehicle-mounted lens assemblies, as a key component of autonomous driving auxiliary systems, play a vital role in the safe driving of autonomous driving vehicles. Users have higher and higher requirements on the size, resolving power and imaging quality of the vehicle-mounted lens assemblies. Particularly, the vehicle-mounted lens assembly in an autonomous driving auxiliary system has special requirements as compared with the common optical lens assembly. For example, the vehicle-mounted lens assembly is required to have a small front-end diameter as much as possible and a strong light transmission capability, and required to be capable to adapting to the change of the light intensity in the external environment. Particularly, the autonomous driving vehicles have higher requirements on the image definition of the optical lens assembly and no ghost images.

With the improvement of the imaging quality of optical lens assemblies, the optical lens assemblies have been widely applied in various fields. For example, in many fields such as intelligent detection, security monitoring, smart phones and automobile auxiliary driving, the optical lens assemblies play an irreplaceable role. At the same time, in order to improve the competitiveness of products, lens assembly manufacturers in many fields have begun to spare no effort to invest a large amount of time and effort in studying the performance of lens assemblies.

In recent years, with the rapid development of autonomous driving auxiliary systems, as a key component of the autonomous driving auxiliary systems to acquire external information, the vehicle-mounted lens assemblies have been greatly improved in its imaging quality, and the requirements for the vehicle-mounted lens assemblies in the market are increasing. For example, in order to meet the requirements of safe driving and special installation positions, the requirements for the vehicle-mounted lens assembly in the autonomous driving auxiliary system are more special and strict than those for the common optical lens assembly.

On the one hand, the vehicle-mounted lens assembly in the autonomous driving auxiliary system is required to be capable of being normally used in dark environments such as at night or in rainy days. Meanwhile, the vehicle-mounted lens assembly is also required to be capable of accurately determining the current road condition. On the other hand, in practice, there may be a large temperature difference (e.g., a high temperature in summer and a low temperature in winter) in the application environment of the vehicle-mounted lens assembly. Most of the lens assemblies applied on this condition will have a deviation of an image plane, which makes the images of the lens assemblies blurred, affecting the normal use. At present, most of the vehicle-mounted lens assemblies on the market cannot guarantee clear images in high and low temperature environments well.

### SUMMARY

An aspect of the present disclosure provide an optical lens assembly. The optical lens assembly comprises, sequentially along an optical axis from an object side to an image side: a first lens, having a negative refractive power, an image-side surface of the first lens being a concave surface; a second lens, having a refractive power, an object-side surface of the second lens being a concave surface, and an image-side surface of the second lens being a convex surface; a third lens, having a positive refractive power, an object-side surface of the third lens being a convex surface, and an image-side surface of the third lens being a convex surface; a fourth lens, having a refractive power, an object-side surface of the fourth lens being a convex surface; a fifth lens, having a refractive power, an image-side surface of the fifth lens being a convex surface; and a sixth lens, having a refractive power.

In an implementation, an object-side surface of the first lens is a convex surface.

In an implementation, an object-side surface of the first lens is a concave surface.

In an implementation, the second lens has a negative refractive power.

In an implementation, the second lens has a positive refractive power.

In an implementation, the fourth lens has a positive refractive power, and an image-side surface of the fourth lens is a convex surface.

In an implementation, the fourth lens has a negative refractive power, and an image-side surface of the fourth lens is a concave surface.

In an implementation, the fifth lens has a negative refractive power, and an object-side surface of the fifth lens is a concave surface.

In an implementation, the fifth lens has a positive refractive power, and an object-side surface of the fifth lens is a convex surface.

In an implementation, the sixth lens has a positive refractive power, an object-side surface of the sixth lens is a convex surface, and an image-side surface of the sixth lens is a concave surface.

In an implementation, the sixth lens has a positive refractive power, an object-side surface of the sixth lens is a concave surface, and an image-side surface of the sixth lens is a convex surface.

In an implementation, the sixth lens has a positive refractive power, an object-side surface of the sixth lens is a convex surface, and an image-side surface of the sixth lens is a convex surface.

In an implementation, the sixth lens has a negative refractive power, an object-side surface of the sixth lens is a convex surface, and an image-side surface of the sixth lens is a concave surface.

In an implementation, the sixth lens has a negative refractive power, an object-side surface of the sixth lens is a concave surface, and an image-side surface of the sixth lens is a convex surface.

In an implementation, the sixth lens has a negative refractive power, an object-side surface of the sixth lens is a concave surface, and an image-side surface of the sixth lens is a concave surface.

In an implementation, the fourth lens and the fifth lens are cemented to form a cemented lens.

In an implementation, the sixth lens has an aspheric surface.

In an implementation, a distance TTL on the optical axis from a center of an object-side surface of the first lens to an image plane of the optical lens assembly, and a total effective focal length F of the optical lens assembly, satisfy: TTL/F≤7.

In an implementation, a maximal field-of-view FOV of the optical lens assembly, a distance TTL on the optical axis from a center of an object-side surface of the first lens to an image plane of the optical lens assembly, and an image height H corresponding to the maximal field-of-view of the optical lens assembly, satisfy: TTL/H/FOV≤0.05.

In an implementation, a maximal field-of-view FOV of the optical lens assembly, a diameter D of maximal aperture of an object-side surface of the first lens corresponding to the maximal field-of-view of the optical lens assembly, and an image height H corresponding to the maximal field-of-view of the optical lens assembly, satisfy: D/H/FOV≤0.03.

In an implementation, an effective focal length F45 of a cemented lens formed by cementing the fourth lens and the fifth lens, and a total effective focal length F of the optical lens assembly, satisfy: 1≤F45/F≤8.

In an implementation, a lens edge slope K2 of the image-side surface of the first lens corresponding to a maximal field-of-view of the optical lens assembly satisfies: arctan(1/K2)≥35.

In an implementation, a maximal field-of-view FOV of the optical lens assembly, a total effective focal length F of the optical lens assembly, and an image height H corresponding to the maximal field-of-view of the optical lens assembly, satisfy: (FOV×F)/H≥70.

In an implementation, a distance d8i on the optical axis from a center of the object-side surface of the fourth lens to an image plane of the optical lens assembly, and a distance TTL on the optical axis from a center of an object-side surface of the first lens to the image plane of the optical lens assembly, satisfy: d8i/TTL≥0.3.

In an implementation, a radius of curvature R3 of the object-side surface of the second lens, a radius of curvature R4 of the image-side surface of the second lens, and a center thickness T2 of the second lens, satisfy: 0.2≤|R4/(|R3|+T2)|≤1.2.

In an implementation, a center thickness Tn1 of an n1-th lens having a largest center thickness in the second lens to the fourth lens, and a center thickness Tm1 of an m1-th lens having a smallest center thickness in the second lens to the fourth lens, satisfy: Tn1/Tm1≤2, wherein n1 and m1 are selected from 2, 3 and 4.

In an implementation, a center thickness Tn2 of an n2-th lens having a largest center thickness in the second lens, the third lens and the fifth lens, and a center thickness Tm2 of an m2-th lens having a smallest center thickness in the second lens, the third lens and the fifth lens, satisfy: Tn2/Tm2≤2, wherein n2 and m2 are selected from 2, 3 and 5.

In an implementation, a refractive index Nd1 of the first lens and a refractive index Nd2 of the second lens satisfy: 0.5≤Nd1/Nd2≤1.5.

In an implementation, an effective focal length F3 of the third lens and an effective focal length F5 of the fifth lens satisfy: 1.2≤|F3/F5|≤2.8.

In an implementation, an effective focal length F3 of the third lens and an effective focal length F4 of the fourth lens satisfy: 1≤|F3/F4|≤3.

In an implementation, an effective focal length F3 of the third lens, an effective focal length F4 of the fourth lens, a temperature coefficient of refractive index dn/dt(3) of the third lens, and a temperature coefficient of refractive index dn/dt(4) of the fourth lens, satisfy: −2×10⁶≤(F3+F4)/(dn/dt(3)+dn/dt(4))≤−4×10⁵.

In an implementation, an effective focal length F3 of the third lens, an effective focal length F5 of the fifth lens, a temperature coefficient of refractive index dn/dt(3) of the third lens, and a temperature coefficient of refractive index dn/dt(5) of the fifth lens, satisfy: −2×10⁶≤(F3+F5)/(dn/dt(3)+dn/dt(5))≤−4×10⁵

In an implementation, a radian θ of a maximal field-of-view of the optical lens assembly, a total effective focal length F of the optical lens assembly, and an image height H corresponding to the maximal field-of-view of the optical lens assembly, satisfy: (H−F×θ)/(F×θ)≤−0.1.

In an implementation, a lens edge slope K11 of an object-side surface of the sixth lens corresponding to a maximal field-of-view of the optical lens assembly satisfies: arctan(1/K11)≤−4.

In an implementation, an f-number FNO of the optical lens assembly and a total effective focal length F of the optical lens assembly satisfy: FNO/F≥0.1.

In an implementation, an effective focal length F4 of the fourth lens and an effective focal length F5 of the fifth lens satisfy: 0.2≤|F4/F5|≤3.

In an implementation, an effective focal length F3 of the third lens and a total effective focal length F of the optical lens assembly satisfy: 1≤|F3/F|≤4.

In an implementation, a distance BFL on the optical axis from a center of an image-side surface of the sixth lens to an image plane of the optical lens assembly, and a distance TTL on the optical axis from a center of an object-side surface of the first lens to the image plane of the optical lens assembly, satisfy: BFL/TTL≥0.05.

In an implementation, a spacing distance d23 on the optical axis from a center of the image-side surface of the second lens to a center of the object-side surface of the third lens, and a distance TTL on the optical axis from a center of an object-side surface of the first lens to an image plane of the optical lens assembly, satisfy: 0.04≤d23/TTL≤0.2.

In an implementation, an effective focal length F6 of the sixth lens and a total effective focal length F of the optical lens assembly satisfy: |F6/F|≥3.5.

In an implementation, an effective focal length F1 of the first lens and a total effective focal length F of the optical lens assembly satisfy: −2.0≤F1/F≤−1.0.

In an implementation, a radius of curvature R10 of the image-side surface of the fifth lens and a total effective focal length F of the optical lens assembly satisfy: −6.0≤R10/F≤−1.0.

In an implementation, a center thickness T2 of the second lens and a distance TTL on the optical axis from a center of an object-side surface of the first lens to an image plane of the optical lens assembly satisfy: T2/TTL≥0.15.

Another aspect of the present disclosure provide an optical lens assembly. The optical lens assembly includes, sequentially along an optical axis from an object side to an image side: a first lens, a second lens, a third lens, a fourth lens, a fifth lens and a sixth lens, where the first lens has a negative refractive power, the third lens has a positive refractive power, and a distance d8i on the optical axis from a center of an object-side surface of the fourth lens to an image plane of the optical lens assembly, and a distance TTL on the optical axis from a center of an object-side surface of the first lens to the image plane of the optical lens assembly, satisfy: d8i/TTL≥0.3.

Another aspect of the present disclosure provide an optical lens assembly. The optical lens assembly includes, sequentially along an optical axis from an object side to an image side: a first lens, having a negative refractive power, an object-side surface of the first lens being a convex surface, and an image-side surface of the first lens being a concave surface; a second lens, having a refractive power, an object-side surface of the second lens being a concave surface, and an image-side surface of the second lens being a convex surface; a third lens, having a positive refractive power, an object-side surface of the third lens being a convex surface, and an image-side surface of the third lens being a convex surface; a fourth lens, having a positive refractive power, an object-side surface of the fourth lens being a convex surface, and an image-side surface of the fourth lens being a convex surface; a fifth lens, having a negative refractive power, an object-side surface of the fifth lens being a concave surface; and a sixth lens, having a positive refractive power, an object-side surface of the sixth lens being a convex surface.

In an implementation, an image-side surface of the fifth lens is a convex surface.

In an implementation, an image-side surface of the fifth lens is a concave surface.

In an implementation, an image-side surface of the sixth lens is a concave surface.

In an implementation, an image-side surface of the sixth lens is a convex surface.

In an implementation, the fourth lens and the fifth lens are cemented to form a cemented lens.

In an implementation, the first lens and the sixth lens has aspheric surfaces.

In an implementation, a distance TTL on the optical axis from a center of the object-side surface of the first lens to an image plane of the optical lens assembly, and a total effective focal length F of the optical lens assembly, satisfy: 4.5≤TTL/F≤7.

In an implementation, a distance TTL on the optical axis from a center of the object-side surface of the first lens to an image plane of the optical lens assembly, a maximal field-of-view FOV of the optical lens assembly, and an image height H corresponding to the maximal field-of-view of the optical lens assembly, satisfy: TTL/H/FOV≤0.05.

In an implementation, a maximal field-of-view FOV of the optical lens assembly, a diameter D of a maximal aperture of the object-side surface of the first lens corresponding to the maximal field-of-view of the optical lens assembly, and an image height H corresponding to the maximal field-of-view of the optical lens assembly, satisfy: D/H/FOV≤0.03.

In an implementation, a maximal field-of-view FOV of the optical lens assembly, a total effective focal length F of the optical lens assembly, and an image height H corresponding to the maximal field-of-view of the optical lens assembly, satisfy: (FOV×F)/H≥65.

In an implementation, an effective focal length F1 of the first lens and a total effective focal length F of the optical lens assembly satisfy: −2.5≤F1/F≤−1.

In an implementation, a lens edge slope K2 of the image-side surface of the first lens corresponding to a maximal field-of-view of the optical lens assembly satisfies: arctan(1/K2)≥35.

In an implementation, a radius of curvature R3 of the object-side surface of the second lens and a radius of curvature R4 of the image-side surface of the second lens satisfy: 0.6≤R3/R4≤1.2.

In an implementation, a radius of curvature R3 of the object-side surface of the second lens, a radius of curvature R4 of the image-side surface of the second lens, and a center thickness d2 of the second lens on the optical axis, satisfy: 1≤R3/(R4+d2)≤2.

In an implementation, a center thickness d2 of the second lens on the optical axis, and a distance TTL on the optical axis from a center of the object-side surface of the first lens to an image plane of the optical lens assembly, satisfy: 0.15≤d2/TTL≤0.3.

In an implementation, an effective focal length F3 of the third lens and a total effective focal length F of the optical lens assembly satisfy: 1.5≤F3/F≤3.5.

In an implementation, a radius of curvature R7 of the image-side surface of the third lens and a total effective focal length F of the optical lens assembly satisfy: R7/F≤−2.

In an implementation, an effective focal length F3 of the third lens and an effective focal length F4 of the fourth lens satisfy: 1≤F3/F4≤2.5.

In an implementation, an effective focal length F45 of a cemented lens formed by cementing the fourth lens and the fifth lens, and a total effective focal length F of the optical lens assembly, satisfy: 2.5≤F45/F≤13.

In an implementation, an abbe number Vd4 of the fourth lens and an abbe number Vd5 of the fifth lens satisfy: 2.6≤Vd4/Vd5≤5.3.

In an implementation, a distance T₈₋ᵢ on the optical axis from a center of the object-side surface of the fourth lens to an image plane of the optical lens assembly, and a distance TTL on the optical axis from a center of the object-side surface of the first lens to the image plane of the optical lens assembly, satisfy: 0.35≤T₈₋ᵢ/TTL≤0.52.

In an implementation, a distance T₈₋₁₁ on the optical axis from a center of the object-side surface of the fourth lens to a center of an image-side surface of the sixth lens, and a radius of curvature R8 of the object-side surface of the fourth lens, satisfy: 1≤(T₈₋₁₁)/R8≤2.

In an implementation, the optical lens assembly further includes an auxiliary lens located between the sixth lens and an image plane of the optical lens assembly, where a distance T₃₋₁₃ on the optical axis from a center of the object-side surface of the second lens to a center of an image-side surface of the auxiliary lens, and a distance TTL on the optical axis from a center of the object-side surface of the first lens to the image plane of the optical lens assembly satisfy: 0.7≤(T₃₋₁₃)/TTL≤0.9.

In an implementation, a lens edge slope K12 of an image-side surface of the sixth lens corresponding to a maximal field-of-view of the optical lens assembly satisfies: arctan(1/K12)≤0.

In an implementation, a radius of curvature R11 of the object-side surface of the sixth lens and a total effective focal length F of the optical lens assembly satisfy: 2≤R11/F≤6.

In an implementation, a sagittal height SAG11 at a maximal aperture of the object-side surface of the sixth lens corresponding to a maximal field-of-view of the optical lens assembly, and a diameter D11 of a maximal aperture of the object-side surface of the sixth lens corresponding to the maximal field-of-view of the optical lens assembly, satisfy: |SAG11/D11/2|≤0.22.

In an implementation, an image height H corresponding to a maximal field-of-view of the optical lens assembly, a total effective focal length F of the optical lens assembly, and the maximal field-of-view θ of the optical lens assembly with a radian as a unit, satisfy: 0.3≤(H/2)/(F×tan(θ/2))≤1.6.

In an implementation, an image height H corresponding to a maximal field-of-view of the optical lens assembly, a diameter D of a maximal aperture of the object-side surface of the first lens corresponding to the maximal field-of-view of the optical lens assembly, and the maximal field-of-view θ of the optical lens assembly with a radian as a unit, satisfy: D/H/θ≤1.0.

Another aspect of the present disclosure provide an optical lens assembly. The optical lens assembly includes, sequentially along an optical axis from an object side to an image side: a first lens, having a negative refractive power; a second lens, having a refractive power; a third lens, having a positive refractive power; a fourth lens, having a positive refractive power; a fifth lens, having a negative refractive power; and a sixth lens, having a positive refractive power, where an image height H corresponding to a maximal field-of-view of the optical lens assembly, a total effective focal length F of the optical lens assembly, and a maximal field-of-view θ of the optical lens assembly with a radian as a unit, satisfy: 0.3≤(H/2)/(F×tan(θ/2))≤1.6.

Another aspect of the present disclosure provide an electronic device. The electronic device includes: the optical lens assembly according to any one of the implementations of present disclosure, and an imaging element used to convert an optical image formed by the optical lens assembly into an electrical signal.

The present disclosure uses six lenses. By optimizing the shapes, refractive powers, etc. of the lenses, the optical lens assembly has at least one beneficial effect such as high resolution, miniaturization, a small front-end diameter, good temperature performance, a large field-of-view, no ghost images, a large center angular resolution, low costs, and a high imaging quality.

### BRIEF DESCRIPTION OF THE DRAWINGS

In combination with the accompanying drawings, other features, objectives and advantages of the present disclosure will become more apparent through the following detailed description for non-limiting embodiments. In the accompanying drawings:

FIG. 1 is a schematic structural diagram of an optical lens assembly according to Embodiment 1 of the present disclosure;

FIG. 2 is a schematic structural diagram of an optical lens assembly according to Embodiment 2 of the present disclosure;

FIG. 3 is a schematic structural diagram of an optical lens assembly according to Embodiment 3 of the present disclosure;

FIG. 4 is a schematic structural diagram of an optical lens assembly according to Embodiment 4 of the present disclosure;

FIG. 5 is a schematic structural diagram of an optical lens assembly according to Embodiment 5 of the present disclosure;

FIG. 6 is a schematic structural diagram of an optical lens assembly according to Embodiment 6 of the present disclosure;

FIG. 7 is a schematic structural diagram of an optical lens assembly according to Embodiment 7 of the present disclosure;

FIG. 8 is a schematic structural diagram of an optical lens assembly according to Embodiment 8 of the present disclosure;

FIG. 9 is a schematic structural diagram of an optical lens assembly according to Embodiment 9 of the present disclosure;

FIG. 10 is a schematic structural diagram of an optical lens assembly according to Embodiment 10 of the present disclosure;

FIG. 11 is a schematic structural diagram of an optical lens assembly according to Embodiment 11 of the present disclosure;

FIG. 12 is a schematic structural diagram of an optical lens assembly according to Embodiment 12 of the present disclosure;

FIG. 13 is a schematic structural diagram of an optical lens assembly according to Embodiment 13 of the present disclosure;

FIG. 14 is a schematic structural diagram of an optical lens assembly according to Embodiment 14 of the present disclosure;

FIG. 15 is a schematic structural diagram of an optical lens assembly according to Embodiment 15 of the present disclosure;

FIG. 16 is a schematic structural diagram of an optical lens assembly according to Embodiment 16 of the present disclosure;

FIG. 17 is a schematic structural diagram of an optical lens assembly according to Embodiment 17 of the present disclosure;

FIG. 18 is a schematic structural diagram of an optical lens assembly according to Embodiment 18 of the present disclosure;

FIG. 19 is a schematic structural diagram of an optical lens assembly according to Embodiment 19 of the present disclosure;

FIG. 20 is a schematic structural diagram of an optical lens assembly according to Embodiment 20 of the present disclosure;

FIG. 21 is a schematic structural diagram of an optical lens assembly according to Embodiment 21 of the present disclosure; and

FIG. 22 is a schematic structural diagram of an optical lens assembly according to Embodiment 22 of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. A surface of each lens that is closest to a photographed object is referred to as the object-side surface of the lens, and a surface of the each lens that is closest to an image side is referred to as the image-side surface of the lens.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list. Further, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The present disclosure will be described below in detail with reference to the accompanying drawings and in combination with the embodiments.

Features, principles and other aspects of the present disclosure are described below in detail.

In exemplary implementations, an optical lens assembly includes, for example, six lenses (i.e., a first lens, a second lens, a third lens, a fourth lens, a fifth lens, and a sixth lens) having refractive powers. The six lenses are arranged in sequence along an optical axis from an object side to an image side.

In an exemplary implementation, the optical lens assembly may further include a photosensitive element disposed on an image plane. Alternatively, the photosensitive element disposed on the image plane may be a charge coupled device (CCD) or complementary metal-oxide semiconductor element (CMOS).

In an exemplary implementation, the first lens may have a negative refractive power. The first lens may have a convex-concave or concave-concave shape. The first lens has a negative refractive power and the image-side surface of the first lens is a concave surface, which is conducive to collecting the light of a large field of view as much as possible to cause the light to enter the rear part of the optical system, fixing the direction trend of the light at a large angle in the edge area and reducing the imaging aberration due to the light at the large angle, thereby facilitating the improvement of the resolution. When the object-side surface of the first lens is a convex surface, a material with a high refractive index (e.g., the refractive index Nd1≥1.8) may be preferably used. When the object-side surface of the first lens is a concave surface, a material with a low refractive index (e.g., the refractive index Nd1≥1.5) may be preferably used, and it is thus conducive to reducing the diameter of the front-end of the optical lens assembly and improving the imaging quality. In practical applications, considering that a vehicle-mounted lens assembly may be used in harsh weather conditions such as in the rain or snow after being installed outdoors, the first lens is a convex-concave meniscus lens, which is conducive to the sliding of water droplets, thereby reducing the influence during the imaging. The first lens may preferably be an aspheric lens to further improve the resolution quality.

In an exemplary implementation, the second lens may have a positive or negative refractive power. The second lens may have a concave-convex shape. The settings for the refractive power and shape of the second lens are conducive to collecting the light emitted from the first lens to make the light transition smooth. Preferably, the shape of the second lens can be close to a concentric circle shape. In this way, there may be an optical path difference between the peripheral ray and the central ray of the optical lens assembly, which is conducive to diverging the central ray to cause the ray to enter the rear part of the optical lens assembly, and which is conducive to reducing the diameter of the front end of the lens assembly to reduce the size of the lens assembly, thereby achieving the miniaturization and reducing costs.

In an exemplary implementation, the third lens may have a positive refractive power. The third lens may have a convex-convex shape. When the third lens has a positive refractive power, the light can be converged by the third lens to make the diverged light enter the rear part of the optical lens assembly smoothly, which is conducive to compressing the light, and thus, the light transition can be further made smooth.

In an exemplary implementation, the fourth lens may have a positive or negative refractive power. The fourth lens may have a convex-convex or convex-concave shape.

In an exemplary implementation, the fifth lens may have a positive or negative refractive power. The fifth lens may have a convex-convex or concave-convex shape.

In an exemplary implementation, the sixth lens may have a positive or negative refractive power. The sixth lens may have a convex-concave, concave-convex, convex-convex, or concave-concave shape. The settings for the refractive power and shape of the sixth lens can make the light from the front end smoothly transit to the image plane of the optical lens assembly, which reduces the total track length of the lens assembly, corrects the astigmatism and field curvature and improves the resolving power of the optical lens assembly. Preferably, the sixth lens may have an aspheric surface to improve the resolution quality.

In an exemplary implementation, the optical lens assembly according to the present disclosure may satisfy: TTL/F≤7. Here, TTL is a distance on the optical axis from a center of the object-side surface of the first lens to the image plane of the optical lens assembly, and F is a total effective focal length of the optical lens assembly. More specifically, TTL and F may further satisfy: TTL/F≤6.5. Satisfying TTL/F≤7 is conducive to achieving miniaturization.

In an exemplary implementation, the optical lens assembly according to the present disclosure may satisfy: TTL/H/FOV≤0.05. Here, FOV is a maximal field-of-view of the optical lens assembly, TTL is the distance on the optical axis from the center of the object-side surface of the first lens to the image plane of the optical lens assembly, and H is an image height corresponding to the maximal field-of-view of the optical lens assembly. More specifically, TTL, H and FOV may further satisfy: TTL/H/FOV≤0.03. Satisfying TTL/H/FOV≤0.05 is conducive to achieving miniaturization.

In an exemplary implementation, the optical lens assembly according to the present disclosure may satisfy: D/H/FOV≤0.03. Here, FOV is the maximal field-of-view of the optical lens assembly, D is the diameter of a maximal aperture of the object-side surface of the first lens corresponding to the maximal field-of-view of the optical lens assembly, and H is the image height corresponding to the maximal field-of-view of the optical lens assembly. More specifically, D, H and FOV may further satisfy: D/H/FOV≤0.01. Satisfying D/H/FOV≤0.03 is conducive to reducing the diameter of the front-end, and thus is conducive to achieving miniaturization.

In an exemplary implementation, the optical lens assembly according to the present disclosure may satisfy: 1≤F45/F≤8. Here, F45 is an effective focal length of a cemented lens formed by cementing the fourth lens and the fifth lens, and F is the total effective focal length of the optical lens assembly. More specifically, F45 and F may further satisfy: 2≤F45/F≤6. When 1≤F45/F≤8 is satisfied, the light trend between the third lens and the sixth lens can be controlled, which reduces the aberration caused by the light entering from the third lens at a large angle, and at the same time, which is conducive to making the structure of the optical lens assembly compact and conducive to the miniaturization.

In an exemplary implementation, the optical lens assembly according to the present disclosure may satisfy: arctan(1/K2)≥35. Here, K2 is a lens edge slope of the image-side surface of the first lens corresponding to the maximal field-of-view of the optical lens assembly. More specifically, K2 may further satisfy: arctan(1/K2)≥42. Satisfying arctan(1/K2)≥35 can make the opening angle of the image-side surface of the first lens larger, which is conducive to quickly focusing the peripheral light entering from the first lens at a large angle to improve the imaging quality.

In an exemplary implementation, the optical lens assembly according to the present disclosure may satisfy: (FOV×F)/H≥70. Here, FOV is the maximal field-of-view of the optical lens assembly, F is the total effective focal length of the optical lens assembly, and H is the image height corresponding to the maximal field-of-view of the optical lens assembly. More specifically, FOV, F and H may further satisfy: (FOV×F)/H≥75. Satisfying (FOV×F)/H≥70 is conducive to making the optical lens assembly have the characteristics of telephoto and large field-of-view at the same time, and helps the optical lens assembly to be capable of having a large field-of-view to achieve large angular resolution while the imaging effect of the optical lens assembly is improved.

In an exemplary implementation, the optical lens assembly according to the present disclosure may satisfy: d8i/TTL≥0.3. Here, d8i is a distance on the optical axis from a center of an object-side surface of the fourth lens to the image plane of the optical lens assembly, and TTL is the distance on the optical axis from the center of the object-side surface of the first lens to the image plane of the optical lens assembly. More specifically, d8i and TTL may further satisfy: d8i/TTL≥0.4. Satisfying d8i/TTL≥0.3 is conducive to eliminating ghost images.

In an exemplary implementation, the optical lens assembly according to the present disclosure may satisfy: 0.2≤|R4/(|R3|+T2)|≤1.2. Here, R3 is a radius of curvature of an object-side surface of the second lens, R4 is a radius of curvature of the image-side surface of the second lens, and T2 is a center thickness of the second lens. More specifically, R4, R3 and T2 may further satisfy: 0.4≤|R4/(|R3|+T2)|≤1. Satisfying 0.2≤|R4/(|R3|+T2)|≤1.2 is conducive to making the surface shapes of the second lens close to concentric circles. In this way, there may be an optical path difference between the peripheral ray and the central ray of the optical lens assembly, which is conducive to diverging the central ray to cause the ray to enter the rear optical lens assembly, and which is conducive to reducing the diameter of the front end of the lens assembly to reduce the size of the lens assembly, thereby achieving the miniaturization and reducing costs.

In an exemplary implementation, the optical lens assembly according to the present disclosure may satisfy: Tn1/Tm1≤2. Here, Tn1 is a center thickness of an n1-th lens having a largest center thickness in the second lens to the fourth lens, Tm1 is a center thickness of an m1-th lens having a smallest center thickness in the second lens to the fourth lens, and n1 and m1 are selected from 2, 3 and 4. More specifically, Tn1 and Tm1 may further satisfy: Tn1/Tm1≤1.5. Satisfying Tn1/Tm1≤2 is conducive to making the center thicknesses of the second lens to the fourth lens similar, which helps the optical lens assembly to have a smooth light trend to make the deflection change small and helps to reduce the sensitivity.

In an exemplary implementation, the optical lens assembly according to the present disclosure may satisfy: Tn2/Tm2≤2. Here, Tn2 is a center thickness of an n2-th lens having a largest center thickness in the second lens, the third lens and the fourth lens, Tm2 is a center thickness of an m2-th lens having a smallest center thickness in the second lens, the third lens and the fourth lens, and n2 and m2 are selected from 2, 3 and 5. More specifically, Tn2 and Tm2 may further satisfy: Tn2/Tm2≤1.7. Satisfying Tn2/Tm2≤2 is conducive to making the center thicknesses of the second lens, the third lens and the fifth lens similar, which helps the optical lens assembly to have a smooth light trend to make the deflection change small and helps to reduce the sensitivity.

In an exemplary implementation, the optical lens assembly according to the present disclosure may satisfy: 0.5≤Nd1/Nd2≤1.5. Here, Nd1 is a refractive index of the first lens, and Nd2 is a refractive index of the second lens. More specifically, Nd1 and Nd2 may further satisfy: 0.9≤Nd1/Nd2≤1.1. Satisfying 0.5≤Nd1/Nd2≤1.5 is conducive to making the refractive index of the first lens and the refractive index of the second lens similar, and when the first lens and the second lens preferably adopt a material with a high refractive index, the direction of the light entering the first lens at a large angle can be quickly changed, which is conducive to reducing the diameter of the front-end of the optical system and improving the imaging quality.

In an exemplary implementation, the optical lens assembly according to the present disclosure may satisfy: 1.2≤|F3/F5|≤2.8. Here, F3 is an effective focal length of the third lens, and F5 is an effective focal length of the fifth lens. More specifically, F3 and F5 may further satisfy: 1.6≤|F3/F5|≤2.51. Satisfying 1.2≤|F3/F5|≤2.8 is helpful for the smooth transition of light, to reduce the aberrations caused by a too steep light trend, a too large angle, etc., which is conducive to improving the image quality.

In an exemplary implementation, the optical lens assembly according to the present disclosure may satisfy: 1≤|F3/F4|≤3. Here, F3 is the effective focal length of the third lens, and F4 is an effective focal length of the fourth lens. More specifically, F3 and F4 may further satisfy: 1.1≤|F3/F4|≤2.5. Satisfying 1≤|F3/F4|≤3 is helpful for the smooth transition of light, to reduce the aberrations caused by a too steep light trend, a too large angle, etc., which is conducive to improving the image quality.

In an exemplary implementation, the optical lens assembly according to the present disclosure may satisfy: −2×10⁶≤(F3+F4)/(dn/dt(3)+dn/dt(4))≤−4×10⁵. Here, F3 is the effective focal length of the third lens, F4 is the effective focal length of the fourth lens, dn/dt(3) is a temperature coefficient of refractive index of the third lens, and dn/dt(4) is a temperature coefficient of refractive index of the fourth lens. More specifically, F3, F4, dn/dt(3) and dn/dt(4) may further satisfy: −1×10⁶≤(F3+F4)/(dn/dt(3)+dn/dt(4))≤−5.7×10⁵. Satisfying −2×10⁶≤(F3+F4)/(dn/dt(3)+dn/dt(4))≤−4×10⁵ helps to reduce the light deflection change of the optical lens assembly in high and low temperature environments, which is conducive to making the optical lens assembly have good temperature performance.

In an exemplary implementation, the optical lens assembly according to the present disclosure may satisfy: −2×10⁶≤(F3+F5)/(dn/dt(3)+dn/dt(5))≤−4×10⁵. Here, F3 is the effective focal length of the third lens, F5 is the effective focal length of the fifth lens, dn/dt(3) is the temperature coefficient of refractive index of the third lens, and dn/dt(5) is a temperature coefficient of refractive index of the fifth lens. More specifically, F3, F5, dn/dt(3) and dn/dt(5) may further satisfy: −9×10⁵≤(F3+F5)/(dn/dt(3)+dn/dt(5))≤−4.8×10⁵. Satisfying −2×10⁶≤(F3+F5)/(dn/dt(3)+dn/dt(5))≤−4×10⁵ helps to reduce the light deflection change of the optical lens assembly in high and low temperature environments, which is conducive to making the optical lens assembly have good temperature performance.

In an exemplary implementation, the optical lens assembly according to the present disclosure may satisfy: (H−F×θ)/(F×θ)≤−0.1. Here, θ is a radian of the maximal field-of-view of the optical lens assembly, F is the total effective focal length of the optical lens assembly, and H is the image height corresponding to the maximal field-of-view of the optical lens assembly. More specifically, H, F and θ may further satisfy: (H−F×θ)/(F×θ)≤−0.2. When (H−F×θ)/(F×θ)≤−0.1 is satisfied, the total effective focal length of the lens assembly can be increased to highlight the imaging effect of the central area of the image plane of the lens assembly when it is ensured that the field-of-view of the lens assembly and the size of the image plane do not change.

In an exemplary implementation, the optical lens assembly according to the present disclosure may satisfy: arctan(1/K11)≤−4. Here, K11 is a lens edge slope of an object-side surface of the sixth lens corresponding to the maximal field-of-view of the optical lens assembly, and arctan(1/K11) is the opening angle of the object-side surface of the sixth lens corresponding to the maximal field-of-view of the optical lens assembly. More specifically, K11 may further satisfy: arctan(1/K11)≤−6. Satisfying arctan(1/K11)≤−4 is helpful to make the edge opening angle of the object-side surface of the sixth lens become a negative value and helpful for the bending to the object-side surface, which is conducive to correcting the astigmatism and field curvature.

In an exemplary implementation, the optical lens assembly according to the present disclosure may satisfy: FNO/F≥0.1. Here, FNO is an f-number of the optical lens assembly, and F is the total effective focal length F of the optical lens assembly. More specifically, FNO and F may further satisfy: FNO/F≥0.28. Satisfying FNO/F≥0.1 is conducive to making the optical lens assembly have a large-aperture characteristic.

In an exemplary implementation, the optical lens assembly according to the present disclosure may satisfy: 0.2≤|F4/F5|≤3. Here, F4 is the effective focal length of the fourth lens, and F5 is the effective focal length of the fifth lens. More specifically, F4 and F5 may further satisfy: 0.6≤|F4/F5|≤2.6. Satisfying 0.2≤|F4/F5|≤3 is helpful for the smooth transition of light, which is conducive to correcting chromatic aberrations.

In an exemplary implementation, the optical lens assembly according to the present disclosure may satisfy: 1≤|F3/F|≤4. Here, F3 is the effective focal length of the third lens, and F is total effective focal length of the optical lens assembly. More specifically, F3 and F may further satisfy: 1.7≤|F3/F|≤3.3. Satisfying 1≤|F3/F|≤4 helps to balance various aberrations of the optical lens assembly.

In an exemplary implementation, the optical lens assembly according to the present disclosure may satisfy: BFL/TTL≥0.05. Here, BFL is a distance on the optical axis from a center of an image-side surface of the sixth lens to the image plane of the optical lens assembly, and TTL is the distance on the optical axis from the center of the object-side surface of the first lens to the image plane of the optical lens assembly. More specifically, BFL and TTL may further satisfy: BFL/TTL≥0.08. When BFL/TTL≥0.05 is satisfied, the structure of the lens assembly can be made compact on the basis of ensuring the miniaturization and assembling characteristics, thereby reducing the sensitivity of the lens to MTF, improving the production yield and reducing the production cost.

In an exemplary implementation, the optical lens assembly according to the present disclosure may satisfy: 0.04≤d23/TTL≤0.2. Here, d23 is a spacing distance on the optical axis from a center of the image-side surface of the second lens to a center of an object-side surface of the third lens, and TTL is the distance on the optical axis from the center of the object-side surface of the first lens to the image plane of the optical lens assembly. More specifically, d23 and TTL may further satisfy: 0.06≤d23/TTL≤0.11. Satisfying 0.04≤d23/TTL≤0.2 can make the spacing distance between the first lens and the second lens small, which is conducive to the miniaturization of the lens assembly, reducing the sensitivity of the lens to MTF and reducing the production cost.

In an exemplary implementation, the optical lens assembly according to the present disclosure may satisfy: |F6/F|≥3.5. Here, F6 is an effective focal length of the sixth lens, and F is the total effective focal length of the optical lens assembly. More specifically, F6 and F may further satisfy: |F6/F|≥4.1. Satisfying |F6/F|≥3.5 helps to improve the resolution to reduce the influence of defocus on the optical lens assembly.

In an exemplary implementation, the optical lens assembly according to the present disclosure may satisfy: −2.0≤F1/F≤−1.0. Here, F1 is an effective focal length of the first lens, and F is the total effective focal length of the optical lens assembly. More specifically, F1 and F may further satisfy: −1.82≤F1/F≤−1.26. Satisfying −2.0≤F1/F≤−1.0 helps to enable more light to smoothly enter the optical lens assembly to increase the illumination.

In an exemplary implementation, the optical lens assembly according to the present disclosure may satisfy: −6.0≤R10/F≤−1.0. Here, R10 is a radius of curvature of an image-side surface of the fifth lens, and F is the total effective focal length of the optical lens assembly. More specifically, R10 and F may further satisfy: −4.8≤R10/F≤−1.4. When −6.0≤R10/F≤−1.0 is satisfied, the image-side surface of the fifth lens can be a convex surface.

In an exemplary implementation, the optical lens assembly according to the present disclosure may satisfy: T2/TTL≥0.15. Here, T2 is the center thickness of the second lens, and TTL is the distance on the optical axis from the center of the object-side surface of the first lens to the image plane of the optical lens assembly. More specifically, T2 and TTL may further satisfy: 0.15≤T2/TTL≤0.3. Satisfying T2/TTL≥0.15 is conducive to collecting the light emitted from the first lens to make the light transition smooth, thereby reducing the sensitivity of the lens to MTF and improving the resolution.

In an exemplary implementation, a diaphragm used to restrict light beams may be disposed between the second lens and the third lens, to further improve the imaging quality of the optical lens assembly. Disposing the diaphragm between the second lens and the third lens is conducive to increasing the diameter of the diaphragm, and thus is conducive to effectively constrain the light entering the optical lens assembly, thereby reducing the diameter of the lens and shortening the total track length of the optical lens assembly. In the implementations of the present disclosure, the diaphragm may be disposed near the image-side surface of the second lens, or near the object-side surface of the third lens. However, it should be noted that the positions of the diaphragm disclosed here are only examples, rather than limitations. In alternative implementations, the diaphragm may be disposed at other positions according to actual needs. For example, the diaphragm may be disposed between the third lens and the fourth lens to further improve the imaging quality of the optical lens assembly.

In an exemplary implementation, the optical lens assembly according to the present disclosure may further include an optical filter and/or a protective glass disposed between the sixth lens and the image plane, to filter light with different wavelengths and prevent the elements (e.g., chips) on the image side of the optical lens assembly from being damaged.

As known to those skilled in the art, the cemented lens can be used to reduce or eliminate chromatic aberrations to the greatest extent. The use of the cemented lens in the optical lens assembly can improve the imaging quality and reduce the reflection loss of light energy, thereby achieving high resolution and improving the image clarity of the lens assembly. In addition, the use of the cemented lens can simplify the assembling procedures in the process of manufacturing the lens assembly.

In an exemplary implementation, the fourth lens and the fifth lens can be cemented to form a cemented lens. The fourth lens having a convex object-side surface and a convex image-side surface and the fifth lens having a concave object-side surface and a convex image-side surface are cemented, or the fourth lens having a convex object-side surface and a concave image-side surface and the fifth lens having a convex object-side surface and a convex image-side surface are cemented, which helps the light passing through the fourth lens smoothly transit to the rear part of the optical system and which is conducive to reducing the total length of the optical lens assembly. Clearly, the fourth lens and the fifth lens may not be cemented, which is conducive to improving the resolving power.

The fourth lens and the fifth lens forming the cemented lens are respectively a lens having a positive refractive power and a lens having a negative refractive power. Here, the lens having a positive refractive power has a low refractive index, and the lens having a negative refractive power has a high refractive index (relative to the lens having a positive refractive power). Moreover, both the object-side surface and the image-side surface of the cemented lens are convex surfaces. In this way, the light can be further converged and then transit to the rear part of the optical system.

The cementing approach between the above lenses has at least one of the following advantages: fully correcting various aberrations of the optical lens assembly, which can improve the resolution and optimize the optical performance such as distortion and a CRA under the premise that the structure of the optical lens assembly is compact; reducing the loss in the amount of light caused by the reflection between the lenses; the collocation of high and low refractive indices being conducive to the quick transition of the light from the front part; and increasing the diameter of the diaphragm to improve the luminous flux, which is helpful for the night vision; reducing the spacing distance between the two lenses, thereby reducing the total length of the system; reducing the assembly part between the lenses, thereby reducing the procedures and cost; reducing the tolerance sensitivity problem of a lens unit caused by the tilt/eccentricity in the assembling process, thereby improving the production yield; the cemented lens may have a positive refractive power, to enable the light to be effectively converged after passing the cemented lens, which makes the light smoothly reach the image plane; and reducing an overall weight and costs. Such cementing design shares the overall chromatic aberration correction of the system, and thus, the aberrations are effectively corrected to improve the resolution. The cementing design makes the optical system compact as a whole, thereby meeting the miniaturization requirement.

In an exemplary implementation, the sixth lens can be an aspheric lens, and the first lens, the second lens, the third lens, the fourth lens and the fifth lens can be spherical lenses. Alternatively, the first lens and the sixth lens can be aspheric lenses, and the second lens, the third lens, the fourth lens and the fifth lens can be spherical lenses. Alternatively, the first lens, the second lens and the sixth lens can be aspheric lenses, and the third lens, the fourth lens and the fifth lens can be spherical lenses. Alternatively, the second lens, the third lens and the sixth lens can be aspheric lenses, and the first lens, the fourth lens and the fifth lens can be spherical lenses. Particularly, in order to improve the resolution quality of the optical system, the first lens, the second lens, the third lens, the fourth lens, the fifth lens and the sixth lens can all be aspheric lenses. An aspheric lens is characterized in that the curvature continuously changes from the center of the lens to the periphery of the lens. Different from a spherical lens having a constant curvature from the center of the lens to the periphery of the lens, the aspheric lens has a better radius-of-curvature characteristic, and has advantages of improving the distortion aberration and improving the astigmatic aberration. The use of the aspheric lens can eliminate as much as possible the aberrations that occur during the imaging, thereby improving the imaging quality of the lens assembly. The setting of the aspheric lens helps to correct the aberrations of the system, thereby improving the resolution.

Through the reasonable settings for the shapes and refractive powers of the lenses, in the situation where only six lenses are used, the optical lens assembly according to the above implementations of the present disclosure enables the optical system to achieve at least one beneficial effect such as high resolution (which can be up to 8 million pixels or more), miniaturization, a long focal length, a large field-of-view, no ghost images and a good imaging quality. At the same time, the optical lens assembly also takes into account the requirements for a small size of the lens assembly, a small front-end diameter, a low sensitivity, little influence on the resolution of the lens assembly in high and low temperatures, a wide range of work and a high production yield. The total effective focal length of the optical lens assembly is long and the central area has large angular resolution, which can improve the recognition for environmental objects and can increase the central detection area with pertinence.

Through the setting of the cemented lens, the optical lens assembly according to the above implementations of the present disclosure can effectively eliminate the influence of ghost images on the optical lens assembly, such that the optical lens assembly has a high resolution quality on the basis of eliminating ghost images. By reasonably distributing the refractive powers and temperature coefficients, the influence of temperature changes on the refractive power of the optical lens assembly can be effectively improved, and the stability of the resolving power of the optical lens assembly at different temperatures can be further improved. The reasonable selection for the lens material is helpful for the smooth light trend, thereby reducing the sensitivity of optical lens assembly.

In an exemplary implementation, the first to sixth lenses in the optical lens assembly may all be made of glass. The optical lens assembly made of glass can suppress the deviation of the back focus of the optical lens assembly caused by a temperature change, to improve the stability of the system. At the same time, the use of the glass material can avoid the influence on the normal use of the lens assembly due to the blurred image of the lens assembly caused by the change of the high and low temperatures in the application environment. Particularly, when the resolution quality and the reliability are focused on, the first to sixth lenses may all be glass aspheric lenses. Clearly, in application scenarios where there are low requirements for the temperature stability, the first to sixth lenses in the optical lens assembly can alternatively all be made of plastic. Using the plastic to make the optical lens assembly can effectively reduce the production cost.

In exemplary implementations, an optical lens assembly includes, for example, six lenses (i.e., a first lens, a second lens, a third lens, a fourth lens, a fifth lens, and a sixth lens) having refractive powers. The six lenses are arranged in sequence along an optical axis from an object side to an image side.

In an exemplary implementation, the optical lens assembly may further include a photosensitive element disposed on an image plane. Alternatively, the photosensitive element disposed on the image plane may be a charge coupled device (CCD) or complementary metal-oxide semiconductor element (CMOS).

In an exemplary implementation, the first lens may have a negative refractive power. The first lens may have a convex-concave shape. The settings for the refractive power and shape of the second lens are conducive to collecting the light in a large field of view as much as possible to cause the light to enter the rear part of the optical system, and conducive to fixing the direction trend of the light at a large angle in the edge area. In practical applications, it is conducive to the sliding of water droplets to reduce the influence of the external environment on the imaging quality of the lens assembly. The first lens may have an aspheric surface, which is conducive to having large angular resolution at the central area and improving the resolution. The first lens may adopt a material with a high refractive index, which is conducive to reducing the diameter of the front-end of the lens assembly and improving the imaging quality.

In an exemplary implementation, the second lens may have a positive or negative refractive power. The second lens may have a concave-convex shape. The settings for the refractive power and shape of the second lens are conducive to collecting the light emitted from the first lens to make the light transition smooth. Surfaces of the second lens may be set to shapes close to concentric circles, which can make the light emitted from the first lens smoothly transit to the rear part of the optical lens assembly, and which is conducive to reducing the diameter of the front-end of the lens assembly and reducing the size of the lens assembly, thereby achieving miniaturization and reducing costs.

In an exemplary implementation, the third lens may have a positive refractive power. The third lens may have a convex-convex shape. The settings for the refractive power and shape of the third lens are conducive to converging light. The third lens can be a dual-convex lens and the lens shape is gentle, which is conducive to making the diverged light enter the rear part smoothly to further make the light transition smooth.

In an exemplary implementation, the fourth lens may have a positive refractive power. The fourth lens may have a convex-convex shape. The settings for the refractive power and shape of the fourth lens are conducive to converging light.

In an exemplary implementation, the fifth lens may have a negative refractive power. The fifth lens may have a concave-convex or concave-concave shape. The settings for the refractive power and shape of the fifth lens are conducive to prevent the light entering the lens assembly from being diverged too much.

In an exemplary implementation, the sixth lens may have a positive refractive power. The sixth lens may have a convex-concave or convex-convex shape. The settings for the refractive power and shape of the sixth lens (particularly, the shape of the six is set to be gentle) are conducive to correcting the astigmatism and field curvature and improving the resolving power of the optical lens assembly.

In an exemplary implementation, the optical lens assembly according to the present disclosure may satisfy: 4.5≤TTL/F≤7. Here, TTL is a distance on the optical axis from a center of an object-side surface of the first lens to the image plane of the optical lens assembly, and F is a total effective focal length of the optical lens assembly. More specifically, TTL and F may further satisfy: 4.5≤TTL/F≤6.8. Satisfying 4.5≤TTL/F≤7 is conducive to achieving miniaturization, and to improving the resolution of the lens assembly and reducing the sensitivity of the lens assembly. If TTL/F is too small, the sensitivity of the lens assembly will be increased.

In an exemplary implementation, the optical lens assembly according to the present disclosure may satisfy: TTL/H/FOV≤0.05. Here, TTL is the distance on the optical axis from the center of the object-side surface of the first lens to the image plane of the optical lens assembly, FOV is a maximal field-of-view of the optical lens assembly, and H is an image height corresponding to the maximal field-of-view of the optical lens assembly. More specifically, TTL, H and FOV may further satisfy: TTL/H/FOV≤0.036. Satisfying TTL/H/FOV≤0.05 is conducive to achieving miniaturization.

In an exemplary implementation, the optical lens assembly according to the present disclosure may satisfy: D/H/FOV≤0.03. Here, FOV is the maximal field-of-view of the optical lens assembly, D is the diameter of a maximal aperture of the object-side surface of the first lens corresponding to the maximal field-of-view of the optical lens assembly, and H is the image height corresponding to the maximal field-of-view of the optical lens assembly. More specifically, D, H and FOV may further satisfy: D/H/FOV≤0.02. Satisfying D/H/FOV≤0.03 is conducive to reducing the front-end diameter, and thus is conducive to achieving miniaturization.

In an exemplary implementation, the optical lens assembly according to the present disclosure may satisfy: (FOV×F)/H≥65. Here, FOV is the maximal field-of-view of the optical lens assembly, F is the total effective focal length of the optical lens assembly, and H is the image height corresponding to the maximal field-of-view of the optical lens assembly. More specifically, FOV, F and H may further satisfy: (FOV×F)/H≥73. Satisfying (FOV×F)/H≥65 is conducive to making the optical lens assembly satisfy the telephoto and the large field-of-view at the same time, and helps the optical lens assembly to be capable of achieving large angular resolution while satisfying a large field-of-view.

In an exemplary implementation, the optical lens assembly according to the present disclosure may satisfy: −2.5≤F1/F≤−1. Here, F1 is an effective focal length of the first lens, and F is the total effective focal length of the optical lens assembly. More specifically, F1 and F may further satisfy: −2≤F1/F≤−1.7. Satisfying −2.5≤F1/F≤−1 is conducive to making the light in a large field-of-view enter the optical lens assembly.

In an exemplary implementation, the optical lens assembly according to the present disclosure may satisfy: arctan(1/K2)≥35. Here, K2 is a lens edge slope of the image-side surface of the first lens corresponding to the maximal field-of-view of the optical lens assembly, and arctan(1/K2) is the opening angle of the image-side surface of the first lens corresponding to the maximal field-of-view of the optical lens assembly. More specifically, K2 may further satisfy: arctan(1/K2)≥36. Satisfying arctan(1/K2)≥35 is conducive to making the field angle of the image-side surface of the first lens large, which is conducive to quickly focusing the peripheral light emitting from the first lens at a large angle to improve the imaging quality.

In an exemplary implementation, the optical lens assembly according to the present disclosure may satisfy: 0.6≤R3/R4≤1.2. Here, R3 is a radius of curvature of an object-side surface of the second lens, and R4 is a radius of curvature of an image-side surface of the second lens. More specifically, R3 and R4 may further satisfy: 0.6≤R3/R4≤1. Satisfying 0.6≤R3/R4≤1.2 is conducive to making the surface shapes of the second lens close to concentric circles, which is conducive to the smooth transition of light.

In an exemplary implementation, the optical lens assembly according to the present disclosure may satisfy: 1≤R3/(R4+d2)≤2. Here, R3 is the radius of curvature of the object-side surface of the second lens, R4 is the radius of curvature of the image-side surface of the second lens, and d2 is a center thickness of the second lens on the optical axis. More specifically, R3, R4 and d2 may further satisfy: 1.3≤R3/(R4+d2)≤1.9. Satisfying 1≤R3/(R4+d2)≤2 is conducive to making the surface shapes of the second lens close to concentric circles, which is conducive to the smooth transition of light.

In an exemplary implementation, the optical lens assembly according to the present disclosure may satisfy: 0.15≤d2/TTL≤0.3. Here, d2 is the center thickness of the second lens on the optical axis, and TTL is the distance on the optical axis from the center of the object-side surface of the first lens to the image plane of the optical lens assembly. More specifically, d2 and TTL may further satisfy: 0.17≤d2/TTL≤0.22. Satisfying 0.15≤d2/TTL≤0.3 is conducive to the processability of the second lens to make the light transition smooth.

In an exemplary implementation, the optical lens assembly according to the present disclosure may satisfy: 1.5≤F3/F≤3.5. Here, F3 is an effective focal length of the third lens, and F is the total effective focal length of the optical lens assembly. More specifically, F3 and F may further satisfy: 1.8≤F3/F≤3. Satisfying 1.5≤F3/F≤3.5 helps to balance various aberrations.

In an exemplary implementation, the optical lens assembly according to the present disclosure may satisfy: R7/F≤−2. Here, R7 is a radius of curvature of an image-side surface of the third lens, and F is the total effective focal length of the optical lens assembly. More specifically, R7 and F may further satisfy: R7/F≤−2.5. Satisfying R7/F≤−2 is conducive to reducing the sensitivity of the third lens.

In an exemplary implementation, the optical lens assembly according to the present disclosure may satisfy: 1≤F3/F4≤2.5. Here, F3 is the effective focal length of the third lens, and F4 is an effective focal length of the fourth lens. More specifically, F3 and F4 may further satisfy: 1.2≤F3/F4≤2.2. Satisfying 1≤F3/F4≤2.5 is helpful for the smooth light transition, which is conducive to improving the image quality.

In an exemplary implementation, the optical lens assembly according to the present disclosure may satisfy: 2.5≤F45/F≤13. Here, F45 is an effective focal length of a cemented lens formed by cementing the fourth lens and the fifth lens, and F is the total effective focal length of the optical lens assembly. More specifically, F45 and F may further satisfy: 3≤F45/F≤12.5. Satisfying 2.5≤F45/F≤13 is conducive to controlling the light trend between the third lens and the sixth lens, which reduces the aberration caused by the light emitted from the third lens at a large angle. At the same time, it is conducive to making the structure of the lenses compact and conducive to the miniaturization.

In an exemplary implementation, the optical lens assembly according to the present disclosure may satisfy: 2.6≤Vd4/Vd5≤5.3. Here, Vd4 is an abbe number of the fourth lens, and Vd5 is an abbe number of the fifth lens. More specifically, Vd4 and Vd5 may further satisfy: 2.8≤Vd4/Vd5≤5.1. Satisfying 2.6≤Vd4/Vd5≤5.3 helps to correct chromatic aberrations.

In an exemplary implementation, the optical lens assembly according to the present disclosure may satisfy: 0.35≤T₈₋ᵢ/TTL≤0.52. Here, T₈₋ᵢ is a distance on the optical axis from a center of an object-side surface of the fourth lens to the image plane of the optical lens assembly, and TTL is the distance on the optical axis from the center of the object-side surface of the first lens to the image plane of the optical lens assembly. More specifically, T₈₋ᵢ and TTL may further satisfy: 0.4≤T₈₋ᵢ/TTL≤0.48. Satisfying 0.35≤T₈₋ᵢ/TTL≤0.52 helps to eliminate ghost images.

In an exemplary implementation, the optical lens assembly according to the present disclosure may satisfy: 1≤(T₈₋₁₁)/R8≤2. Here, T₈₋₁₁ is a distance on the optical axis from the center of the object-side surface of the fourth lens to a center of an image-side surface of the sixth lens, and R8 is a radius of curvature of the object-side surface of the fourth lens. More specifically, T₈₋₁₁ and R8 may further satisfy: 1≤(T₈₋₁₁)/R8≤1.6. Satisfying 1≤(T₈₋₁₁)/R8≤2 is conducive to increasing the spacing distance between the fourth lens and the sixth lens, to reduce the energy of ghost images generated by the reflection in the central areas of the fourth lens to the sixth lens. Moreover, it is conducive to reducing the radius of curvature of the object-side surface of the fourth lens, to reduce the energy of ghost images generated by the reflection in the edge areas of the fourth lens to the sixth lens when being projected on the image plane.

In an exemplary implementation, the optical lens assembly further includes an auxiliary lens located between the sixth lens and an image plane. The optical lens assembly according to the present disclosure may satisfy: 0.7≤(T₃₋₁₃)/TTL≤0.9. Here, T₃₋₁₃ is a distance on the optical axis from a center of the object-side surface of the second lens to a center of an image-side surface of the auxiliary lens, and TTL is the distance on the optical axis from the center of the object-side surface of the first lens to the image plane of the optical lens assembly. More specifically, T₃₋₁₃ and TTL may further satisfy: 0.72≤(T₃₋₁₃)/TTL≤0.85. Satisfying 0.7≤(T₃₋₁₃)/TTL≤0.9 helps to reduce the energy of ghost images generated by the reflection by the second lens and the auxiliary lens when being projected on the image plane.

In an exemplary implementation, the optical lens assembly according to the present disclosure may satisfy: arctan(1/K12)≤0. Here, K12 is a lens edge slope of the image-side surface of the sixth lens corresponding to the maximal field-of-view of the optical lens assembly. More specifically, K12 may further satisfy: arctan(1/K12)≤−1. Satisfying arctan(1/K12)≤0 can make the opening angle at the central area of the image-side surface of the sixth lens become a positive opening angle bending to the image-side surface, and the opening angle at the edge area become zero or a negative opening angle bending to the object-side surface. In this way, the opening angles at the central area and the edge area of the image-side surface of the sixth lens are different in direction, such that the sixth lens has an inflection point on the image-side surface, which is conducive to correcting the astigmatism and field curvature and improving the resolution.

In an exemplary implementation, the optical lens assembly according to the present disclosure may satisfy: 2≤R11/F≤6. Here, R11 is a radius of curvature of an object-side surface of the sixth lens, and F is the total effective focal length of the optical lens assembly. More specifically, R11 and F may further satisfy: 2≤R11/F≤5.5. Satisfying 2≤R11/F≤6 is helpful for the smooth light transition, thereby reducing the sensitivity of the lens assembly.

In an exemplary implementation, the optical lens assembly according to the present disclosure may satisfy: |SAG11/D11/2|≤0.22. Here, SAG11 is a sagittal height at a maximal aperture of the object-side surface of the sixth lens corresponding to the maximal field-of-view of the optical lens assembly (i.e., SAG11 is a distance from an intersection of the object-side surface of the sixth lens and the optical axis to the maximal aperture of the object-side surface of the sixth lens corresponding to the maximal field-of-view of the optical lens assembly on the optical axis), and D11 is the diameter of the maximal aperture of the object-side surface of the sixth lens corresponding to the maximal field-of-view of the optical lens assembly. More specifically, SAG11 and D11 may further satisfy: |SAG11/D11/2|≤0.2. Satisfying |SAG11/D11/2|≤0.22 is helpful for the smooth light transition, thereby reducing the sensitivity of the lens assembly.

In an exemplary implementation, the optical lens assembly according to the present disclosure may satisfy: 0.3≤(H/2)/(F×tan(θ/2))≤1.6. Here, H is the image height corresponding to the maximal field-of-view of the optical lens assembly, F is the total effective focal length of the optical lens assembly, and θ is the maximal field-of-view of the optical lens assembly with a radian as a unit. More specifically, H, F and θ may further satisfy: 0.35≤(H/2)/(F×tan(θ/2))≤1.5. Satisfying 0.3≤(H/2)/(F×tan(θ/2))≤1.6 is conducive to achieving large angular resolution.

In an exemplary implementation, the optical lens assembly according to the present disclosure may satisfy: Nd1≥1.75. Here, Nd1 is an abbe number of the first lens. More specifically, Nd1 may further satisfy: Nd1≥1.78. Satisfying Nd1≥1.75 is conducive to quickly changing the optical path of the light entering the first lens at a large angle, reducing the front-end diameter, and improving the imaging quality.

In an exemplary implementation, the optical lens assembly according to the present disclosure may satisfy: dn3/dt3≤−5.0×10-6. Here, dn3/dt3 is a temperature coefficient of refractive index of the third lens, that is, a variation of the refractive index of the third lens with the change of the temperature. Satisfying dn3/dt3≤−5.0×10-6 helps the lens assembly to maintain good resolution under high temperatures, which makes the lens assembly have good temperature performance

In an exemplary implementation, the optical lens assembly according to the present disclosure may satisfy: dn4/dt4≤−5.0×10-6. Here, dn4/dt4 is a temperature coefficient of refractive index of the fourth lens, that is, a variation of the refractive index of the fourth lens with the change of the temperature. Satisfying dn4/dt4≤−5.0×10-6 helps the lens assembly to maintain good resolution under high temperatures, which makes the lens assembly have good temperature performance

In an exemplary implementation, the optical lens assembly according to the present disclosure may satisfy: 1.1≤FNO≤2.3. Here, FNO is an f-number of the optical lens assembly. More specifically, FNO may further satisfy: 1.3≤FNO≤2.2. Satisfying 1.1≤FNO≤2.3 is conducive to achieving a large-aperture characteristic.

In an exemplary implementation, the optical lens assembly according to the present disclosure may satisfy: D/H/θ≤1.0. Here, H is the image height corresponding to the maximal field-of-view of the optical lens assembly, D is the diameter of a maximal aperture of the object-side surface of the first lens corresponding to the maximal field-of-view of the optical lens assembly, and θ is the maximal field-of-view of the optical lens assembly with a radian as a unit. More specifically, D, H and θ may further satisfy: D/H/θ≤0.8. Satisfying D/H/θ≤1.0 is conducive to reducing the front-end diameter.

In an exemplary implementation, a diaphragm used to restrict light beams may be disposed between the second lens and the third lens to further improve the imaging quality of the optical lens assembly. Disposing the diaphragm between the second lens and the third lens is conducive to effectively constrain the light entering the optical lens assembly, thereby shortening the total track length of the lens assembly and reducing the diameter of the lens group at the front end. In the implementations of the present disclosure, the diaphragm may be disposed near the image-side surface of the second lens, or near the object-side surface of the third lens. However, it should be noted that the positions of the diaphragm disclosed here are only examples, rather than limitations. In alternative implementations, the diaphragm may be disposed at other positions according to actual needs.

In an exemplary implementation, the auxiliary lens disposed between the sixth lens and the image plane may be an optical filter and/or a protective glass, to filter light with different wavelengths and prevent the elements (e.g., chips) on the second side of the optical lens assembly from being damaged.

As known to those skilled in the art, the cemented lens can be used to reduce or eliminate chromatic aberrations to the greatest extent. The use of the cemented lens in the optical lens assembly can improve the imaging quality and reduce the reflection loss of light energy, thereby achieving high resolution and improving the image clarity of the lens assembly. In addition, the use of the cemented lens can simplify the assembling procedures in the process of manufacturing the lens assembly.

In an exemplary implementation, the fourth lens and the fifth lens can be cemented to form a cemented lens. By cementing the fourth lens having a positive refractive power, a convex object-side surface and a convex image-side surface and the fifth lens having a negative refractive power and a concave object-side surface, the light emitted from the previous lens can smoothly transit to the image plane of the optical lens assembly, which is conducive to making the structure of the optical lens assembly compact to reduce the size of the optical lens assembly, and which is conducive to correcting various aberrations of the optical lens assembly, thereby reducing the matching sensitivity of the lenses, improving the resolution and optimizing the optical performance such as distortion and a CRA. The refractive index of the fifth lens having a negative refractive power can be higher than that of the fourth lens having a positive refractive power, such that the light can be effectively and smoothly converged at the rear portion of the lens assembly, to cause the light to reach the image plane smoothly, which is conducive to reducing the overall weight of the lens assembly and reducing the manufacturing cost. When the fifth lens having a high refractive index and the fourth lens having a low refractive index are matched to form a cemented lens, it is conducive to the quick transition of the light from the front part and increasing the diameter of the diaphragm to improve the luminous flux, which is helpful during the night vision. Clearly, the fourth lens and the fifth lens may not be cemented, which is conducive to improving the resolving power.

The cementing approach between the above lenses has at least one of the following advantages: reducing the chromatic aberrations of the lenses, reducing a tolerance sensitivity, and balancing the overall chromatic aberration of the system through residual chromatic aberrations; reducing the spacing distance between the two lenses, thereby reducing the total length of the system; reducing the assembly part between the lenses, thereby reducing the procedures and cost; reducing the tolerance sensitivity problem of a lens unit caused by the tilt/eccentricity in the assembling process, thereby improving the production yield; reducing the loss in the amount of light caused by the reflection between the lenses, thereby improving illumination; and capable of further reducing a field curvature, thereby correcting the off-axis point aberration of the system. Such cementing design shares the overall chromatic aberration correction of the system, and thus, the aberrations are effectively corrected to improve the resolution. The cementing design makes the optical system compact as a whole, thereby meeting the miniaturization requirement.

In an exemplary implementation, the second lens, the third lens, the fourth lens and the fifth lens can be spherical lenses, and the first lens and the sixth lens can be aspheric lenses. The present disclosure does not specifically limit the specific numbers of spherical lenses and aspheric lenses, and the number of aspheric lenses can be increased when the resolution quality is focused on. Specifically, in order to improve the resolution quality of the optical system, the first lens, the second lens, the third lens, the fourth lens, the fifth lens and the sixth lens can all be aspheric lenses. An aspheric lens is characterized in that the curvature continuously changes from the center of the lens to the periphery of the lens. Different from a spherical lens having a constant curvature from the center of the lens to the periphery of the lens, the aspheric lens has a better radius-of-curvature characteristic, and has advantages of improving the distortion aberration and improving the astigmatic aberration. The use of the aspheric lens can eliminate as much as possible the aberrations that occur during the imaging, thereby improving the imaging quality. The setting of the aspheric lens helps to correct the aberrations of the system, thereby improving the resolution.

Through the reasonable settings for the shapes and refractive powers of the lenses, in the situation where only six lenses are used, the optical lens assembly according to the above implementations of the present disclosure enables the optical lens assembly to achieve at least one beneficial effect such as high resolution (which can be up to 8 million pixels or more), miniaturization, a small front-end diameter, good temperature performance, a long focal length, a large field-of-view, no ghost images, a large center angular resolution, low costs, and a good imaging quality. The optical lens assembly can have as many as 8 million pixels or more, which is conducive to achieving higher definition. The optical lens assembly can have a long focal length and have large angular resolution in the central area, which can improve the recognition for environmental objects and can increase the central detection area with pertinence. At the same time, the optical lens assembly has good temperature performance, which is conducive to the small change in imaging effects under high and low temperature environments, a stable imaging quality, the little influence on the resolution of the lens assembly in high and low temperatures and a wide temperature range of work of the optical lens assembly, and thus, the optical lens assembly can be used in most environments.

The optical lens assembly according to the above implementations of the present disclosure is provided with the cemented lens to share the overall chromatic aberration correction of the system, which is not only conducive to correcting the aberration of the system, improving the resolution quality of the system and reducing the problem of matching sensitivity, but also conducive to making the overall structure of the optical system compact and meeting the miniaturization requirement. The above cemented lens can further effectively eliminate the influence of ghost images on the lens assembly, such that the lens assembly has high resolution on the basis of eliminating ghost images.

In an exemplary implementation, the first lens, the second lens, the third lens, the fourth lens, the fifth lens and the sixth lens may all be glass lenses. By setting the optical lens assembly to an all-glass structure and reasonably setting the lenses having different temperature coefficients of refractive index, the lens assembly can still form an image clearly in high and low temperature use environments (e.g., −40° C.-120° C.), which can greatly improve the safety of autonomous driving. The optical lens assembly made of glass can suppress the deviation of the back focus of the optical lens assembly caused by a temperature change, to improve the stability of the system. At the same time, the use of the glass material can avoid the influence on the normal use of the lens assembly due to the blurred image of the lens assembly caused by the change of the high and low temperatures in the use environment. Specifically, when the resolution quality and the reliability are the focused on, the first to sixth lenses may all be glass aspheric lenses. Clearly, in application scenarios where there are low requirements for the temperature stability, the first to sixth lenses in the optical lens assembly can alternatively all be made of plastic. Using the plastic to make the optical lens assembly can effectively reduce the production cost. Clearly, the first to sixth lenses in the optical lens assembly can alternatively be jointly made of plastic and glass.

However, it should be understood by those skilled in the art that the various results and advantages described in the present specification may be obtained by changing the number of the lenses constituting the optical lens assembly without departing from the technical solution claimed by the present disclosure. For example, although the optical lens assembly having six lenses is described as an example in the implementations, the optical lens assembly is not limited to including the six lenses. If desired, the optical lens assembly may also include other numbers of lenses.

Specific embodiments of the optical lens assembly that may be applicable to the above implementations are further described below with reference to the accompanying drawings.

### Embodiment 1

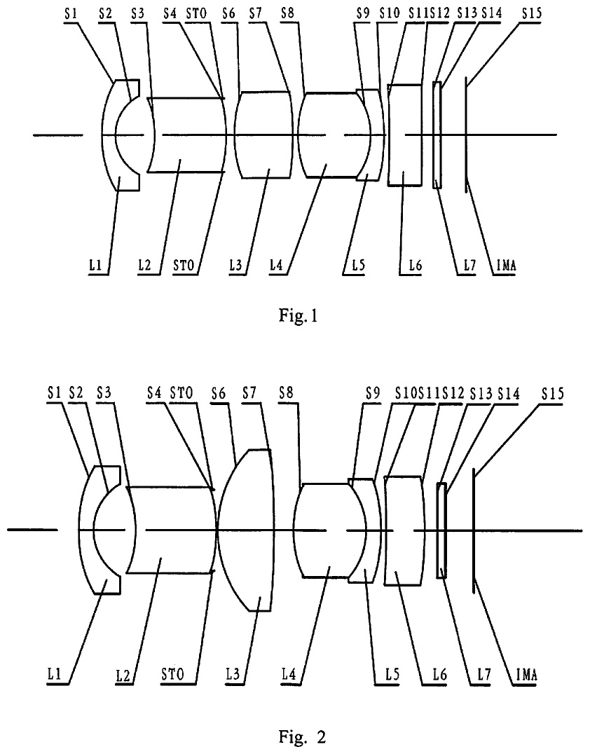

An optical lens assembly according to Embodiment 1 of the present disclosure is described below with reference to FIG. 1. FIG. 1 is a schematic structural diagram of the optical lens assembly according to Embodiment 1 of the present disclosure.

As shown in FIG. 1, the optical lens assembly includes, sequentially along an optical axis from an object side to an image side, a first lens L1, a second lens L2, a third lens L3, a fourth lens L4, a fifth lens L5, and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a negative refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

Table 1 shows a radius of curvature R, a thickness T/distance d (it should be understood that the thickness T/distance d in the row of S1 refers to the center thickness T1 of the first lens L1, the thickness T/distance d in the row of S2 refers to the spacing distance d23 between the image-side surface of the first lens L1 and the object-side surface of the second lens L2, and so on), a refractive index Nd and an abbe number Vd of each lens of the optical lens assembly in Embodiment 1.

TABLE 1

| | radius of | thickness T/ | | |
|---|---|---|---|---|
| surface | curvature | distance d | refractive | abbe number |
| number | R (mm) | (mm) | index Nd | Vd |
| S1 | 3.6229 | 1.0000 | 1.80 | 40.94 |
| S2 | 2.1379 | 2.8948 | | |
| S3 | −7.2440 | 5.3000 | 1.80 | 46.57 |
| S4 | −10.4890 | −0.2500 | | |
| STO | infinite | 0.8873 | | |
| S6 | 8.9700 | 4.3100 | 1.62 | 63.41 |
| S7 | −22.1230 | 0.3947 | | |
| S8 | 7.7910 | 5.3900 | 1.50 | 81.59 |
| S9 | −5.1360 | 1.0000 | 1.92 | 18.90 |
| S10 | −12.9130 | 0.4020 | | |
| S11 | 26.4408 | 2.4000 | 1.59 | 61.12 |
| S12 | 24.2724 | 0.8500 | | |
| S13 | infinite | 0.5500 | 1.52 | 64.21 |
| S14 | infinite | 1.8865 | | |
| S15(IMA) | infinite | | | |

In Embodiment 1, the first lens L1 and the sixth lens L6 may be aspheric lenses, and the second lens L2, the third lens L3, the fourth lens L4 and the fifth lens L5 may be spherical lenses. The surface type x of each aspheric lens may be defined using, but not limited to, the following formula:

$$x = \frac{{ch}^{2}}{1 + \sqrt{1 - ( k + 1 ) {c}^{2} {h}^{2}}} + \sum {Aih}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Table 2 below gives the conic coefficients k and the high-order coefficients A4, A6, A8, A10, A12, A14 and A16 applicable to the aspheric surfaces S1, S2, S11 and S12 in Embodiment 1.

TABLE 2

| surface | | | | | | | | |
|---|---|---|---|---|---|---|---|---|
| number | k | A4 | A6 | A8 | A10 | A12 | A14 | A16 |
| S1 | −3.1704 | 7.4997E−04 | −7.9448E−04 | 8.8113E−05 | −4.9096E−06 | 1.4556E−07 | −1.8308E−09 | / |
| S2 | −0.9243 | −6.5621E−03 | −2.6063E−04 | 4.6197E−05 | 1.4470E−05 | −2.7975E−06 | 2.1144E−07 | −6.0683E−09 |
| S11 | −0.9240 | −2.3208E−03 | 4.1138E−05 | −8.9721E−06 | −2.3641E−07 | 2.1322E−07 | −1.9688E−08 | 5.8682E−10 |
| S12 | −51.8989 | −1.6228E−03 | −1.8583E−05 | 1.2243E−06 | 1.5610E−07 | −1.9680E−09 | −1.1862E−10 | 2.2063E−12 |

### Embodiment 2

An optical lens assembly according to Embodiment 2 of the present disclosure is described below with reference to FIG. 2. In this embodiment and the following embodiments, for the sake of brevity, some descriptions similar to those in Embodiment 1 will be omitted. FIG. 2 is a schematic structural diagram of the optical lens assembly according to Embodiment 2 of the present disclosure.

As shown in FIG. 2, the optical lens assembly includes, sequentially along an optical axis from an object side to an image side, a first lens L1, a second lens L2, a third lens L3, a fourth lens L4, a fifth lens L5, and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a negative refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the first lens L1 and the sixth lens L6 may be aspheric lenses, and the second lens L2, the third lens L3, the fourth lens L4 and the fifth lens L5 may be spherical lenses.

Table 3 shows a radius of curvature R, a thickness T/distance d, a refractive index Nd and an abbe number Vd of each lens of the optical lens assembly in Embodiment 2. Table 4 shows the conic coefficients and the high-order coefficients applicable to the aspheric surfaces in Embodiment 2. Here, the surface type of each aspheric surface may be defined using the formula (1) given in Embodiment 1.

TABLE 3

| | radius of | thickness T/ | | |
|---|---|---|---|---|
| surface | curvature | distance d | refractive | abbe number |
| number | R (mm) | (mm) | index Nd | Vd |
| S1 | 3.6533 | 1.0000 | 1.80 | 40.94 |
| S2 | 2.1174 | 2.8098 | | |
| S3 | −7.1278 | 5.3995 | 1.80 | 46.57 |
| S4 | −9.8135 | −0.2500 | | |
| STO | infinite | 0.3493 | | |
| S6 | 7.9245 | 3.7802 | 1.62 | 63.41 |
| S7 | −57.1518 | 1.3074 | | |
| S8 | 7.3238 | 4.8695 | 1.50 | 81.59 |
| S9 | −4.8311 | 1.0000 | 1.92 | 18.90 |
| S10 | −10.7016 | 0.3565 | | |
| S11 | 24.2947 | 2.5756 | 1.74 | 49.34 |
| S12 | 20.3536 | 0.8500 | | |
| S13 | infinite | 0.5500 | 1.52 | 64.21 |
| S14 | infinite | 1.8989 | | |
| S15(IMA) | infinite | | | |

TABLE 4

| surface | | | | | | | | |
|---|---|---|---|---|---|---|---|---|
| number | k | A4 | A6 | A8 | A10 | A12 | A14 | A16 |
| S1 | −3.0252 | −3.4380E−04 | −6.3504E−04 | 7.7416E−05 | −4.4814E−06 | 1.3407E−07 | −1.6527E−09 | / |
| S2 | −0.9225 | −8.5204E−03 | −2.5436E−04 | 4.2431E−05 | 1.0040E−05 | −2.0406E−06 | 1.3847E−07 | −3.1649E−09 |
| S11 | 6.7045 | −2.2124E−03 | −3.3276E−05 | 5.9600E−07 | 5.0553E−08 | 4.9668E−09 | −5.9603E−11 | 5.4900E−12 |
| S12 | −22.8974 | −2.0657E−03 | −1.3803E−05 | −3.2269E−06 | 5.6733E−07 | −3.6367E−08 | −1.3170E−09 | −2.1644E−11 |

### Embodiment 3

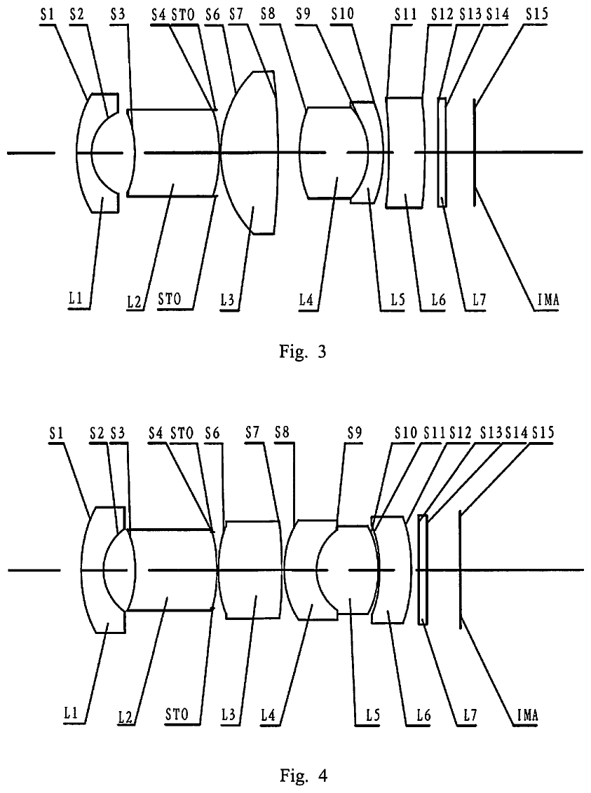

An optical lens assembly according to Embodiment 3 of the present disclosure is described below with reference to FIG. 3. FIG. 3 is a schematic structural diagram of the optical lens assembly according to Embodiment 3 of the present disclosure.

As shown in FIG. 3, the optical lens assembly includes, sequentially along an optical axis from an object side to an image side, a first lens L1, a second lens L2, a third lens L3, a fourth lens L4, a fifth lens L5, and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a negative refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the first lens L1 and the sixth lens L6 may be aspheric lenses, and the second lens L2, the third lens L3, the fourth lens L4 and the fifth lens L5 may be spherical lenses.

Table 5 shows a radius of curvature R, a thickness T/distance d, a refractive index Nd and an abbe number Vd of each lens of the optical lens assembly in Embodiment 3. Table 6 shows the conic coefficients and the high-order coefficients applicable to the aspheric surfaces in Embodiment 3. Here, the surface type of each aspheric surface may be defined using the formula (1) given in Embodiment 1.

TABLE 5

| | radius of | thickness T/ | | |
|---|---|---|---|---|
| surface | curvature | distance d | refractive | abbe number |
| number | R (mm) | (mm) | index Nd | Vd |
| S1 | 3.6642 | 1.0000 | 1.80 | 40.94 |
| S2 | 2.1145 | 2.8701 | | |
| S3 | −7.3344 | 5.6084 | 1.80 | 46.57 |
| S4 | −9.6314 | −0.2500 | | |
| STO | infinite | 0.3500 | | |
| S6 | 7.7361 | 3.8176 | 1.62 | 63.41 |
| S7 | −49.8839 | 1.4319 | | |
| S8 | 7.9561 | 4.5791 | 1.50 | 81.59 |
| S9 | −4.5372 | 1.0000 | 1.92 | 18.90 |
| S10 | −9.2509 | 0.3764 | | |
| S11 | 64.2692 | 2.4001 | 1.69 | 31.08 |
| S12 | 25.7394 | 0.8500 | | |
| S13 | infinite | 0.5500 | 1.52 | 64.21 |
| S14 | infinite | 1.9007 | | |
| S15(IMA) | infinite | | | |

TABLE 6

| surface | | | | | | | | |
|---|---|---|---|---|---|---|---|---|
| number | k | A4 | A6 | A8 | A10 | A12 | A14 | A16 |
| S1 | −2.7714 | −4.1194E−04 | −5.5112E−04 | 6.1233E−05 | −3.3135E−06 | 9.3891E−08 | −1.1041E−09 | / |
| S2 | −0.8662 | −7.5765E−03 | 4.2000E−04 | 6.6432E−05 | 1.7956E−06 | −8.0670E−07 | 5.5181E−08 | −1.0879E−09 |
| S11 | 42.2396 | −2.4958E−03 | 2.7700E−05 | −5.3142E−07 | 1.8533E−07 | −9.3191E−09 | 8.4192E−10 | −3.3605E−11 |
| S12 | −35.6562 | −2.3279E−03 | −2.6900E−05 | −9.5496E−07 | 4.1756E−07 | −3.1262E−08 | 1.2763E−09 | −2.3454E−11 |

### Embodiment 4

An optical lens assembly according to Embodiment 4 of the present disclosure is described below with reference to FIG. 4. FIG. 4 is a schematic structural diagram of the optical lens assembly according to Embodiment 4 of the present disclosure.

As shown in FIG. 4, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a convex-concave lens having a negative refractive power, an object-side surface S8 of the fourth lens L4 is a convex surface, and an image-side surface S9 of the fourth lens L4 is a concave surface. The fifth lens L5 is a dual-convex lens having a positive refractive power, an object-side surface S9 of the fifth lens L5 is a convex surface, and an image-side surface S10 of the fifth lens L5 is a convex surface. The sixth lens L6 is a dual-concave lens having a negative refractive power, an object-side surface S11 of the sixth lens L6 is a concave surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the first lens L1 and the sixth lens L6 may be aspheric lenses, and the second lens L2, the third lens L3, the fourth lens L4 and the fifth lens L5 may be spherical lenses.

Table 7 shows a radius of curvature R, a thickness T/distance d, a refractive index Nd and an abbe number Vd of each lens of the optical lens assembly in Embodiment 4. Table 8 shows the conic coefficients and the high-order coefficients applicable to the aspheric surfaces in Embodiment 4. Here, the surface type of each aspheric surface may be defined using the formula (1) given in Embodiment 1.

TABLE 7

| | radius of | thickness T/ | | |
|---|---|---|---|---|
| surface | curvature | distance d | refractive | abbe number |
| number | R (mm) | (mm) | index Nd | Vd |
| S1 | 5.8070 | 1.4975 | 1.80 | 40.94 |
| S2 | 2.8533 | 2.1263 | | |
| S3 | −7.1333 | 5.4789 | 1.88 | 40.81 |
| S4 | −10.1416 | −0.3000 | | |
| STO | infinite | 0.4000 | | |
| S6 | 8.7766 | 4.2736 | 1.62 | 63.41 |
| S7 | −30.9744 | 0.1529 | | |
| S8 | 6.2506 | 2.1914 | 1.92 | 18.90 |
| S9 | 3.3237 | 4.1305 | 1.50 | 81.59 |
| S10 | −6.5259 | 0.1000 | | |
| S11 | −30.8592 | 2.1412 | 1.59 | 61.12 |
| S12 | 22.7148 | 0.4849 | | |
| S13 | infinite | 0.5500 | 1.52 | 64.21 |
| S14 | infinite | 2.2528 | | |
| S15(IMA) | infinite | | | |

TABLE 8

| surface | | | | | | | | |
|---|---|---|---|---|---|---|---|---|
| number | k | A4 | A6 | A8 | A10 | A12 | A14 | A16 |
| S1 | −8.3933 | 2.9512E−03 | −3.5859E−04 | 2.0008E−05 | −6.8328E−07 | 1.2222E−08 | −7.2949E−11 | / |
| S2 | −1.0264 | −4.1463E−05 | 3.4627E−04 | −1.0313E−04 | 1.3124E−05 | −3.0582E−08 | −9.5680E−08 | 5.5215E−09 |
| S11 | −100.0000 | −7.0230E−03 | 3.4286E−04 | −5.2749E−05 | 6.2724E−06 | −2.9739E−07 | 9.7134E−09 | / |
| S12 | −0.7354 | −5.8211E−03 | 7.7404E−06 | 6.6708E−07 | 2.6942E−07 | −1.2841E−08 | 3.8521E−10 | / |

### Embodiment 5

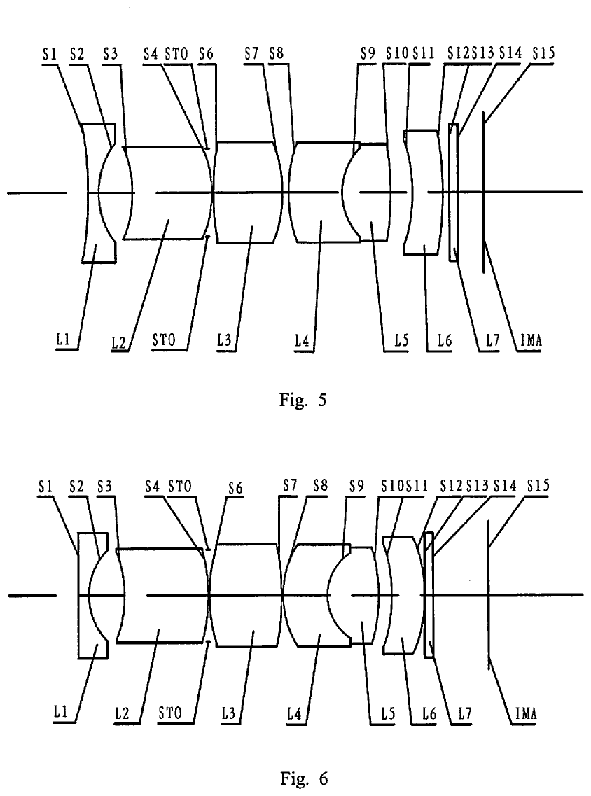

An optical lens assembly according to Embodiment 5 of the present disclosure is described below with reference to FIG. 5. FIG. 5 is a schematic structural diagram of the optical lens assembly according to Embodiment 5 of the present disclosure.

As shown in FIG. 5, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a dual-concave lens having a negative refractive power, an object-side surface S1 of the first lens L1 is a concave surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a convex-concave lens having a negative refractive power, an object-side surface S8 of the fourth lens L4 is a convex surface, and an image-side surface S9 of the fourth lens L4 is a concave surface. The fifth lens L5 is a dual-convex lens having a positive refractive power, an object-side surface S9 of the fifth lens L5 is a convex surface, and an image-side surface S10 of the fifth lens L5 is a convex surface. The sixth lens L6 is a convex-concave lens having a negative refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the first lens L1, the second lens L2 and the sixth lens L6 may be aspheric lenses, and the third lens L3, the fourth lens L4 and the fifth lens L5 may be spherical lenses.

Table 9 shows a radius of curvature R, a thickness T/distance d, a refractive index Nd and an abbe number Vd of each lens of the optical lens assembly in Embodiment 5. Table 10 shows the conic coefficients and the high-order coefficients applicable to the aspheric surfaces in Embodiment 5. Here, the surface type of each aspheric surface may be defined using the formula (1) given in Embodiment 1.

TABLE 9

| | radius of | thickness T/ | | |
|---|---|---|---|---|
| surface | curvature | distance d | refractive | abbe number |
| number | R (mm) | (mm) | index Nd | Vd |
| S1 | −10.8912 | 0.7000 | 1.59 | 61.12 |
| S2 | 7.0728 | 2.2185 | | |
| S3 | −10.4067 | 5.2570 | 1.59 | 61.12 |
| S4 | −7.4187 | −0.3000 | | |
| STO | infinite | 0.4000 | | |
| S6 | 17.5108 | 4.5878 | 1.50 | 81.59 |
| S7 | −8.8027 | 0.4030 | | |
| S8 | 9.6951 | 3.5538 | 1.92 | 18.90 |
| S9 | 4.2917 | 3.2164 | 1.50 | 81.59 |
| S10 | −18.7029 | 1.4382 | | |
| S11 | 23.4286 | 1.9943 | 1.59 | 61.12 |
| S12 | 14.9293 | 0.4500 | | |
| S13 | infinite | 0.5500 | 1.52 | 64.21 |
| S14 | infinite | 1.7142 | | |
| S15(IMA) | infinite | | | |

TABLE 10

| surface | | | | | | | |
|---|---|---|---|---|---|---|---|
| number | k | A4 | A6 | A8 | A10 | A12 | A14 |
| S1 | −15.3377 | 5.6779E−04 | 4.3049E−05 | −4.7198E−06 | 1.8551E−07 | −2.7856E−09 | / |
| S2 | −1.8492 | 2.6494E−03 | −6.1590E−05 | 1.7750E−05 | −2.2206E−06 | 1.3416E−07 | / |
| S3 | −16.3208 | −3.9195E−03 | 1.1965E−04 | −5.3035E−06 | 1.4400E−07 | 1.5488E−08 | / |
| S4 | −0.9462 | −3.2260E−04 | 1.5004E−06 | 6.2211E−07 | −4.4706E−08 | 3.6441E−10 | / |
| S11 | 32.4364 | −3.0199E−03 | −1.7490E−04 | −2.2185E−05 | 2.2066E−06 | −1.3121E−07 | 2.9327E−09 |
| S12 | 8.4486 | −5.1205E−03 | 1.4219E−04 | −6.8490E−06 | 4.3636E−07 | −2.6791E−08 | 6.1174E−10 |

### Embodiment 6

An optical lens assembly according to Embodiment 6 of the present disclosure is described below with reference to FIG. 6. FIG. 6 is a schematic structural diagram of the optical lens assembly according to Embodiment 6 of the present disclosure.

As shown in FIG. 6, the optical lens assembly includes, sequentially along an optical axis from an object side to an image side, a first lens L1, a second lens L2, a third lens L3, a fourth lens L4, a fifth lens L5, and a sixth lens L6.

The first lens L1 is a dual-concave lens having a negative refractive power, an object-side surface S1 of the first lens L1 is a concave surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a convex-concave lens having a negative refractive power, an object-side surface S8 of the fourth lens L4 is a convex surface, and an image-side surface S9 of the fourth lens L4 is a concave surface. The fifth lens L5 is a dual-convex lens having a positive refractive power, an object-side surface S9 of the fifth lens L5 is a convex surface, and an image-side surface S10 of the fifth lens L5 is a convex surface. The sixth lens L6 is a concave-convex lens having a negative refractive power, an object-side surface S11 of the sixth lens L6 is a concave surface, and an image-side surface S12 of the sixth lens L6 is a convex surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the first lens L1 and the sixth lens L6 may be aspheric lenses, and the second lens L2, the third lens L3, the fourth lens L4 and the fifth lens L5 may be spherical lenses.

Table 11 shows a radius of curvature R, a thickness T/distance d, a refractive index Nd and an abbe number Vd of each lens of the optical lens assembly in Embodiment 6. Table 11 shows the conic coefficients and the high-order coefficients applicable to the aspheric surfaces in Embodiment 6. Here, the surface type of each aspheric surface may be defined using the formula (1) given in Embodiment 1.

TABLE 11

| | radius of | thickness T/ | | |
|---|---|---|---|---|
| surface | curvature | distance d | refractive | abbe number |
| number | R (mm) | (mm) | index Nd | Vd |
| S1 | −99.9539 | 0.7000 | 1.69 | 53.15 |
| S2 | 6.0217 | 2.3211 | | |
| S3 | −8.1281 | 5.5001 | 1.80 | 46.57 |
| S4 | −11.8004 | 0.0000 | | |
| STO | infinite | 0.1000 | | |
| S6 | 11.1091 | 4.7572 | 1.50 | 81.59 |
| S7 | −16.2110 | 0.1000 | | |
| S8 | 6.3774 | 2.9146 | 1.92 | 18.90 |
| S9 | 3.3678 | 3.3558 | 1.50 | 81.59 |
| S10 | −10.8543 | 0.8802 | | |
| S11 | −34.4423 | 2.1583 | 1.59 | 61.12 |
| S12 | −103.3700 | 0.0000 | | |
| S13 | infinite | 0.5500 | 1.52 | 64.21 |
| S14 | infinite | 3.6647 | | |
| S15(IMA) | infinite | | | |

TABLE 12

| surface | | | | | | | |
|---|---|---|---|---|---|---|---|
| number | k | A4 | A6 | A8 | A10 | A12 | A14 |
| S1 | −198.9042 | 1.4715E−03 | −2.2507E−04 | 1.9181E−05 | −9.6253E−07 | 2.6666E−08 | −3.1499E−10 |
| S2 | 0.4017 | 2.6322E−03 | 1.4700E−04 | −1.0518E−06 | 2.7418E−06 | −2.2299E−07 | 7.8720E−09 |
| S11 | 87.3767 | −3.2157E−03 | −2.8924E−04 | 9.1790E−05 | −1.2611E−05 | 8.4720E−07 | −1.8020E−08 |
| S12 | −162.3540 | −4.5246E−03 | −1.2679E−05 | 1.5514E−05 | −1.4420E−06 | 5.1453E−08 | 2.7655E−10 |

### Embodiment 7

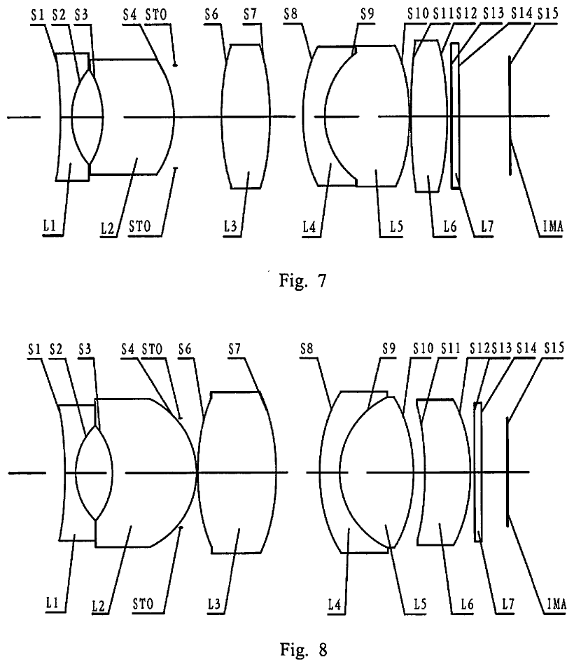

An optical lens assembly according to Embodiment 7 of the present disclosure is described below with reference to FIG. 7. FIG. 7 is a schematic structural diagram of the optical lens assembly according to Embodiment 7 of the present disclosure.

As shown in FIG. 7, the optical lens assembly includes, sequentially along an optical axis from an object side to an image side, a first lens L1, a second lens L2, a third lens L3, a fourth lens L4, a fifth lens L5, and a sixth lens L6.

The first lens L1 is a dual-concave lens having a negative refractive power, an object-side surface S1 of the first lens L1 is a concave surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a convex-concave lens having a negative refractive power, an object-side surface S8 of the fourth lens L4 is a convex surface, and an image-side surface S9 of the fourth lens L4 is a concave surface. The fifth lens L5 is a dual-convex lens having a positive refractive power, an object-side surface S9 of the fifth lens L5 is a convex surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the first lens L1, the second lens L2 and the sixth lens L6 may be aspheric lenses, and the third lens L3, the fourth lens L4 and the fifth lens L5 may be spherical lenses.

Table 13 shows a radius of curvature R, a thickness T/distance d, a refractive index Nd and an abbe number Vd of each lens of the optical lens assembly in Embodiment 7. Table 14 shows the conic coefficients and the high-order coefficients applicable to the aspheric surfaces in Embodiment 7. Here, the surface type of each aspheric surface may be defined using the formula (1) given in Embodiment 1.

TABLE 13

| | radius of | thickness T/ | | |
|---|---|---|---|---|
| surface | curvature | distance d | refractive | abbe number |
| number | R (mm) | (mm) | index Nd | Vd |
| S1 | −17.6277 | 0.8000 | 1.59 | 61.12 |
| S2 | 5.6371 | 2.1974 | | |
| S3 | −8.6898 | 5.0139 | 1.80 | 41.00 |
| S4 | −7.7228 | 0.1000 | | |
| STO | infinite | 3.2599 | | |
| S6 | 18.4476 | 3.4330 | 1.62 | 63.41 |
| S7 | −18.4476 | 2.3283 | | |
| S8 | 11.6639 | 1.5603 | 1.92 | 20.88 |
| S9 | 5.6000 | 5.9928 | 1.50 | 81.59 |
| S10 | −12.8233 | 0.1000 | | |
| S11 | 11.6656 | 2.5473 | 1.59 | 61.12 |
| S12 | 16.2126 | 0.3000 | | |
| S13 | infinite | 0.5500 | 1.52 | 64.21 |
| S14 | infinite | 3.5924 | | |
| S15(IMA) | infinite | | | |

TABLE 14

| surface | | | | | | |
|---|---|---|---|---|---|---|
| number | k | A4 | A6 | A8 | A10 | A12 |
| S1 | −78.7929 | −1.7086E−03 | 2.2152E−04 | −1.2834E−05 | 4.1091E−07 | −5.4148E−09 |
| S2 | −1.6450 | 5.8671E−04 | −5.4425E−05 | 4.0754E−05 | −4.5292E−06 | 2.0623E−07 |
| S3 | −1.6059 | −2.1102E−03 | −2.1603E−05 | −6.9406E−06 | 7.8482E−07 | −1.5028E−08 |
| S4 | 0.6516 | −4.0241E−05 | 1.9518E−06 | 8.1706E−08 | 4.7985E−09 | −2.2795E−10 |
| S11 | 1.0341 | −7.8035E−04 | −1.8000E−05 | −1.8397E−07 | −2.8490E−09 | 1.9579E−11 |
| S12 | 6.7367 | −1.5571E−03 | −3.9319E−05 | −1.6091E−07 | 5.2270E−08 | −1.1756E−09 |

### Embodiment 8

An optical lens assembly according to Embodiment 8 of the present disclosure is described below with reference to FIG. 8. FIG. 8 is a schematic structural diagram of the optical lens assembly according to Embodiment 8 of the present disclosure.

As shown in FIG. 8, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a dual-concave lens having a negative refractive power, an object-side surface S1 of the first lens L1 is a concave surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a convex-concave lens having a negative refractive power, an object-side surface S8 of the fourth lens L4 is a convex surface, and an image-side surface S9 of the fourth lens L4 is a concave surface. The fifth lens L5 is a dual-convex lens having a positive refractive power, an object-side surface S9 of the fifth lens L5 is a convex surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the first lens L1, the second lens L2, and the sixth lens L6 may be aspheric lenses, and the third lens L3, the fourth lens L4, and the fifth lens L5 may be spherical lenses.

Table 15 shows a radius of curvature R, a thickness T/distance d, a refractive index Nd and an abbe number Vd of each lens of the optical lens assembly in Embodiment 8. Table 16 shows the conic coefficients and the high-order coefficients applicable to the aspheric surfaces in Embodiment 8. Here, the surface type of each aspheric surface may be defined using the formula (1) given in Embodiment 1.

TABLE 15

| | radius of | thickness T/ | | |
|---|---|---|---|---|
| surface | curvature | distance d | refractive | abbe number |
| number | R (mm) | (mm) | index Nd | Vd |
| S1 | −21.7141 | 0.7960 | 1.59 | 61.12 |
| S2 | 5.0952 | 2.7460 | | |
| S3 | −8.0319 | 6.2400 | 1.59 | 61.12 |
| S4 | −6.4689 | −1.2000 | | |
| STO | infinite | 1.3000 | | |
| S6 | 15.5856 | 5.8493 | 1.50 | 81.59 |
| S7 | −15.5856 | 3.2430 | | |
| S8 | 12.0783 | 1.4900 | 1.92 | 18.90 |
| S9 | 6.1600 | 5.5000 | 1.50 | 81.59 |
| S10 | −11.6200 | 0.8460 | | |
| S11 | 34.9730 | 3.4002 | 1.59 | 61.12 |
| S12 | 34.9833 | 0.3000 | | |
| S13 | infinite | 0.5500 | 1.52 | 64.21 |
| S14 | infinite | 1.9110 | | |
| S15(IMA) | infinite | | | |

TABLE 16

| surface | | | | | | |
|---|---|---|---|---|---|---|
| number | k | A4 | A6 | A8 | A10 | A12 |
| S1 | −82.6330 | −2.1419E−03 | 2.3776E−04 | −1.3249E−05 | 4.1272E−07 | −1.4171E−09 |
| S2 | −3.5819 | 1.7700E−03 | −1.3263E−04 | 4.8750E−05 | −4.9310E−06 | 2.0624E−07 |
| S3 | −1.4262 | −2.1994E−03 | −2.0235E−05 | −8.1673E−06 | 8.5492E−07 | −1.4975E−08 |
| S4 | 0.3494 | 1.2901E−04 | 8.8864E−06 | −2.4915E−07 | 2.3458E−08 | −2.2872E−10 |
| S11 | 36.6879 | −7.6346E−04 | −2.8191E−05 | 5.2104E−07 | −3.6088E−08 | 3.8810E−11 |
| S12 | 39.6221 | −1.2379E−03 | −9.1617E−05 | 2.2907E−06 | 1.9263E−08 | −1.1761E−09 |

### Embodiment 9

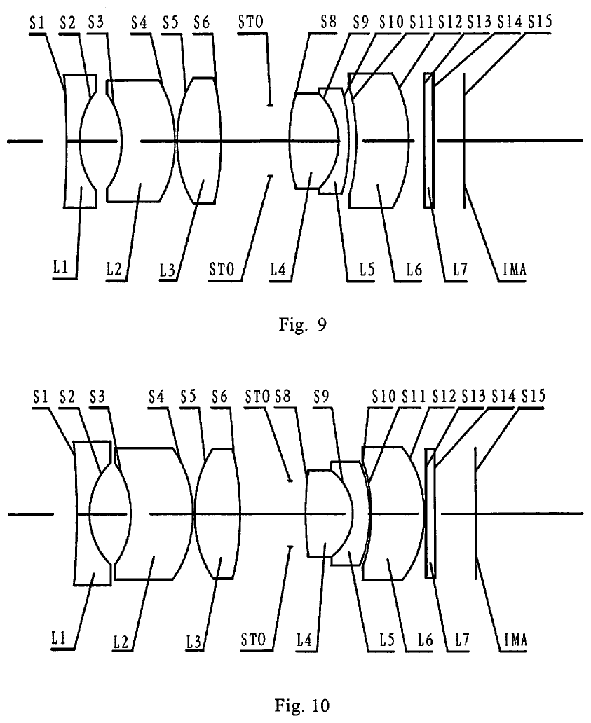

An optical lens assembly according to Embodiment 9 of the present disclosure is described below with reference to FIG. 9. FIG. 9 is a schematic structural diagram of the optical lens assembly according to Embodiment 9 of the present disclosure.

As shown in FIG. 9, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a dual-concave lens having a negative refractive power, an object-side surface S1 of the first lens L1 is a concave surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed at a position near the object-side surface S8 of the fourth lens L4 between the third lens L3 and the fourth lens L4.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the second lens L2, the third lens L3 and the sixth lens L6 may be aspheric lenses, and the first lens L1, the fourth lens L4 and the fifth lens L5 may be spherical lenses.

Table 17 shows a radius of curvature R, a thickness T/distance d, a refractive index Nd and an abbe number Vd of each lens of the optical lens assembly in Embodiment 9. Table 18 shows the conic coefficients and the high-order coefficients applicable to the aspheric surfaces in Embodiment 9. Here, the surface type of each aspheric surface may be defined using the formula (1) given in Embodiment 1.

TABLE 17

| | radius of | thickness T/ | | |
|---|---|---|---|---|
| surface | curvature | distance d | refractive | abbe number |
| number | R (mm) | (mm) | index Nd | Vd |
| S1 | −83.9299 | 0.8000 | 1.65 | 33.84 |
| S2 | 4.6584 | 2.4604 | | |
| S3 | −8.8275 | 5.1901 | 1.80 | 41.00 |
| S4 | −7.4227 | 0.1000 | | |
| S5 | 28.9322 | 2.8568 | | |
| S6 | −12.8311 | 1.9415 | 1.62 | 63.41 |
| STO | infinite | 2.0537 | | |
| S8 | 10.3809 | 3.3415 | 1.62 | 63.41 |
| S9 | −5.0000 | 0.8500 | 1.92 | 20.88 |
| S10 | −18.2695 | 1.0000 | | |
| S11 | 61.2148 | 2.8562 | 1.59 | 61.12 |
| S12 | 70.2331 | 0.9301 | | |
| S13 | infinite | 0.5500 | 1.52 | 64.21 |
| S14 | infinite | 1.8820 | | |
| S15(IMA) | infinite | | | |

TABLE 18

| surface | | | | | | | | |
|---|---|---|---|---|---|---|---|---|
| number | k | A4 | A6 | A8 | A10 | A12 | A14 | A16 |
| S3 | 2.1446 | −1.3895E−03 | −1.2895E−05 | 7.0920E−06 | −1.4005E−07 | 5.4569E−15 | 5.7808E−19 | 3.3087E−22 |
| S4 | −0.5905 | 3.1235E−04 | 2.9977E−05 | −3.2432E−07 | 5.8481E−08 | −9.4809E−10 | −3.1037E−11 | −2.3211E−21 |
| S5 | 2.4808 | 1.9211E−04 | 2.2383E−05 | −2.0846E−06 | 2.0749E−07 | −1.2501E−09 | 9.2822E−11 | −1.1382E−12 |
| S6 | 5.8065 | −5.4344E−04 | −2.0462E−05 | 5.2470E−06 | −2.8138E−07 | 2.9250E−09 | 4.2593E−11 | 1.5574E−12 |
| S11 | 100.0000 | −2.0284E−03 | −5.5268E−05 | 1.1165E−05 | −8.0881E−07 | 2.2811E−08 | −1.2846E−10 | 9.2090E−12 |
| S12 | −100.0000 | −2.8317E−03 | −1.4488E−05 | 5.9739E−06 | −3.4085E−07 | 7.1462E−09 | 2.1056E−11 | −3.8502E−13 |

### Embodiment 10

An optical lens assembly according to Embodiment 10 of the present disclosure is described below with reference to FIG. 10. FIG. 10 is a schematic structural diagram of the optical lens assembly according to Embodiment 10 of the present disclosure.

As shown in FIG. 10, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a dual-concave lens having a negative refractive power, an object-side surface S1 of the first lens L1 is a concave surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a concave-convex lens having a positive refractive power, an object-side surface S11 of the sixth lens L6 is a concave surface, and an image-side surface S12 of the sixth lens L6 is a convex surface. The fourth lens L4 and the fifth lens L5 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed at a position near the object-side surface S8 of the fourth lens L4 between the third lens L3 and the fourth lens L4.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane S15.

In this embodiment, the second lens L2, the third lens L3 and the sixth lens L6 may be aspheric lenses, and the first lens L1, the fourth lens L4 and the fifth lens L5 may be spherical lenses.

Table 19 shows a radius of curvature R, a thickness T/distance d, a refractive index Nd and an abbe number Vd of each lens of the optical lens assembly in Embodiment 10. Table 20 shows the conic coefficients and the high-order coefficients applicable to the aspheric surfaces in Embodiment 10. Here, the surface type of each aspheric surface may be defined using the formula (1) given in Embodiment 1.

TABLE 19

| | radius of | thickness T/ | | |
|---|---|---|---|---|
| surface | curvature | distance d | refractive | abbe number |
| number | R (mm) | (mm) | index Nd | Vd |
| S1 | −55.0727 | 0.8000 | 1.65 | 33.84 |
| S2 | 4.4701 | 2.5338 | | |
| S3 | −5.5041 | 3.8273 | 1.80 | 41.00 |
| S4 | −6.8839 | 0.1000 | | |
| S5 | 6.3866 | 2.8138 | | |
| S6 | −28.3019 | 3.0962 | 1.62 | 63.41 |
| STO | infinite | 0.9540 | | |
| S8 | 18.3457 | 2.9176 | 1.62 | 63.41 |
| S9 | −3.3274 | 1.0320 | 1.92 | 20.88 |
| S10 | −8.4584 | 0.1000 | | |
| S11 | −33.6855 | 3.2785 | 1.59 | 61.12 |
| S12 | −34.6579 | 0.1000 | | |
| S13 | infinite | 0.5500 | 1.52 | 64.21 |
| S14 | infinite | 2.5138 | | |
| S15(IMA) | infinite | | | |

TABLE 20

| surface | | | | | | |
|---|---|---|---|---|---|---|
| number | k | A4 | A6 | A8 | A10 | A12 |
| S3 | −0.1311 | −2.8570E−04 | −1.1071E−05 | 3.9981E−06 | −1.3715E−07 | −2.0579E−19 |
| S4 | 0.1024 | 1.9283E−05 | 1.9377E−05 | −7.9504E−08 | −4.2562E−09 | −6.2519E−19 |
| S5 | −1.6061 | 1.8421E−04 | 1.3411E−05 | −3.3735E−06 | 2.7030E−07 | −1.2283E−08 |
| S6 | −0.5515 | −3.5990E−04 | −5.3693E−05 | 6.6341E−06 | −4.5626E−07 | 8.5693E−09 |
| S11 | 75.5480 | −2.7985E−03 | 4.1325E−05 | −8.0360E−06 | −2.0062E−08 | 2.0688E−08 |
| S12 | 61.1293 | −4.3146E−03 | 5.2225E−05 | 4.9216E−07 | −9.6047E−08 | 2.3432E−09 |

### Embodiment 11

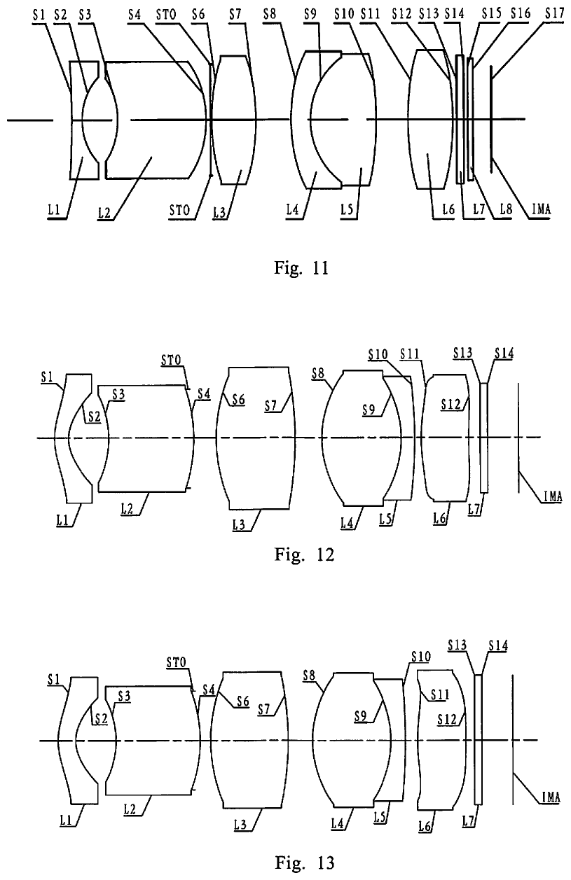

An optical lens assembly according to Embodiment 11 of the present disclosure is described below with reference to FIG. 11. FIG. 11 is a schematic structural diagram of the optical lens assembly according to Embodiment 11 of the present disclosure.

As shown in FIG. 11, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a dual-concave lens having a negative refractive power, an object-side surface S1 of the first lens L1 is a concave surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a convex-concave lens having a negative refractive power, an object-side surface S8 of the fourth lens L4 is a convex surface, and an image-side surface S9 of the fourth lens L4 is a concave surface. The fifth lens L5 is a dual-convex lens having a positive refractive power, an object-side surface S9 of the fifth lens L5 is a convex surface, and an image-side surface S10 of the fifth lens L5 is a convex surface. The sixth lens L6 is a dual-convex lens having a positive refractive power, an object-side surface S11 of the sixth lens L6 is a convex surface, and an image-side surface S12 of the sixth lens L6 is a convex surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the object-side surface S6 of the third lens L3 between the second lens L2 and the third lens L3.

Alternatively, the optical lens assembly may further include an optical filter L7 having an object-side surface S13 and an image-side surface S14. The optical filter L7 may be used to correct color deviations. The optical lens assembly may further include a protective glass L8 having an object-side surface S15 and an image-side surface S16. The protective glass L8 may be used to protect an image sensing chip IMA at an image plane S17. Light from an object sequentially passes through the surfaces S1-S16 and finally forms an image on the image plane S17.

In this embodiment, the first lens L1, the second lens L2 and the sixth lens L6 may be aspheric lenses, and the third lens L3, the fourth lens L4 and the fifth lens L5 may be spherical lenses.

Table 21 shows a radius of curvature R, a thickness T/distance d, a refractive index Nd and an abbe number Vd of each lens of the optical lens assembly in Embodiment 11. Table 22 shows the conic coefficients and the high-order coefficients applicable to the aspheric surfaces in Embodiment 11. Here, the surface type of each aspheric surface may be defined using the formula (1) given in Embodiment 1.

TABLE 21

| | radius of | thickness T/ | | |
|---|---|---|---|---|
| surface | curvature | distance d | refractive | abbe number |
| number | R (mm) | (mm) | index Nd | Vd |
| S1 | −330.1216 | 0.8000 | 1.59 | 61.12 |
| S2 | 4.6613 | 2.7000 | | |
| S3 | −7.2810 | 6.7356 | 1.80 | 41.00 |
| S4 | −7.8863 | 0.3309 | | |
| STO | infinite | 0.1000 | | |
| S6 | 15.8147 | 3.3696 | 1.62 | 63.41 |
| S7 | −15.8147 | 2.6834 | | |
| S8 | 12.5435 | 1.4922 | 1.92 | 20.88 |
| S9 | 6.0000 | 5.0000 | 1.50 | 81.59 |
| S10 | −22.8595 | 2.4382 | | |
| S11 | 15.8471 | 3.4000 | 1.59 | 61.12 |
| S12 | −200.0000 | 0.3000 | | |
| S13 | infinite | 0.5500 | 1.52 | 64.21 |
| S14 | infinite | 0.3000 | | |
| S15 | infinite | 0.4000 | 1.52 | 64.21 |
| S16 | infinite | 1.4000 | | |
| S17(IMA) | infinite | | | |

TABLE 22

| surface | | | | | | | | |
|---|---|---|---|---|---|---|---|---|
| number | k | A4 | A6 | A8 | A10 | A12 | A14 | A16 |
| S1 | 100.0000 | −2.2324E−03 | 2.4548E−04 | −1.3712E−05 | 4.2317E−07 | −5.4033E−09 | 2.4709E−24 | 8.0991E−30 |
| S2 | −2.0904 | −1.2495E−04 | 7.3804E−05 | 3.3917E−05 | −4.4699E−06 | 2.0623E−07 | −3.7445E−29 | 2.1373E−33 |
| S3 | −1.7437 | −2.1064E−03 | −6.5028E−06 | −9.5015E−06 | 9.2515E−07 | −4.4950E−08 | 1.6295E−29 | 3.8694E−32 |
| S4 | −0.4554 | −1.6488E−04 | −1.6112E−07 | −1.6982E−07 | 9.3420E−09 | 2.4709E−24 | 2.7703E−24 | −1.5915E−28 |
| S11 | −0.8221 | −1.0214E−04 | 3.7426E−06 | −6.7555E−07 | 1.0646E−08 | 8.8793E−11 | / | / |
| S12 | −52.0076 | −5.9389E−04 | 3.4949E−06 | −2.1297E−06 | 9.5205E−08 | −1.2056E−09 | / | / |

### Embodiment 12

An optical lens assembly according to Embodiment 12 of the present disclosure is described below with reference to FIG. 12. FIG. 12 is a schematic structural diagram of the optical lens assembly according to Embodiment 12 of the present disclosure.

As shown in FIG. 12, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane S15. Light from an object sequentially passes through the surfaces S1-S14 and finally forms an image on the image plane.

Table 23 shows a radius of curvature R, a thickness d/distance Tᵢ (it should be understood that the thickness d/distance Tᵢ in the row of S1 refers to the center thickness d1 of the first lens L1, the thickness d/distance Tᵢ in the row of S2 refers to the spacing distance T₂₋₃ between the image-side surface S2 of the first lens L1 and the object-side surface S3 of the second lens L2, and so on), a refractive index Nd and an abbe number Vd of each lens of the optical lens assembly in Embodiment 12. Table 24 shows the conic coefficients and the high-order coefficients applicable to the aspheric surfaces in Embodiment 12. Here, the surface type of each aspheric surface may be defined using the formula (1) given in Embodiment 1.

TABLE 23

| | radius of | thickness d/ | | |
|---|---|---|---|---|
| surface | curvature | distance Tᵢ | refractive | abbe number |
| number | R (mm) | (mm) | index Nd | Vd |
| S1 | 5.1485 | 1.0270 | 1.81 | 41.00 |
| S2 | 2.7763 | 2.9426 | | |
| S3 | −7.3158 | 6.2500 | 1.80 | 46.60 |
| S4 | −11.5000 | −0.4000 | | |
| STO | infinite | 2.0604 | | |
| S6 | 12.0509 | 5.8000 | 1.62 | 63.40 |
| S7 | −26.4248 | 2.0016 | | |
| S8 | 8.0414 | 5.8088 | 1.50 | 81.60 |
| S9 | −8.0414 | 1.0000 | 1.92 | 18.90 |
| S10 | −35.0996 | 0.4814 | | |
| S11 | 12.6845 | 3.5000 | 1.59 | 61.10 |
| S12 | 31.3548 | 0.8500 | | |
| S13 | infinite | 0.5500 | 1.52 | 64.20 |
| S14 | infinite | 2.2652 | | |
| IMA | / | / | | |

TABLE 24

| surface | | | | | | | | |
|---|---|---|---|---|---|---|---|---|
| number | k | A4 | A6 | A8 | A10 | A12 | A14 | A16 |
| S1 | −0.7746 | −4.7954E−03 | 6.9622E−05 | 6.5826E−06 | −4.3875E−07 | 7.0948E−09 | 1.8230E−10 | −5.6927E−12 |
| S2 | −1.7143 | −1.2089E−03 | 6.8087E−05 | −1.9206E−05 | 6.9711E−06 | −8.7421E−07 | 5.1451E−08 | −1.1514E−09 |
| S11 | 5.3844 | −1.3634E−03 | −3.5918E−06 | −4.6289E−06 | 5.2286E−07 | −3.5142E−08 | 1.2801E−09 | −1.9688E−12 |
| S12 | −139.8538 | −4.8702E−04 | −4.5477E−05 | −1.0243E−06 | 3.0507E−07 | −1.8725E−08 | 5.8121E−10 | −7.2925E−12 |

### Embodiment 13

An optical lens assembly according to Embodiment 13 of the present disclosure is described below with reference to FIG. 13. FIG. 13 is a schematic structural diagram of the optical lens assembly according to Embodiment 13 of the present disclosure.

As shown in FIG. 13, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a dual-convex lens having a positive refractive power, an object-side surface S11 of the sixth lens L6 is a convex surface, and an image-side surface S12 of the sixth lens L6 is a convex surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 25 shows a radius of curvature R, a thickness d/distance Tᵢ, a refractive index Nd and an abbe number Vd of each lens of the optical lens assembly in Embodiment 13. Table 26 shows the conic coefficients and the high-order coefficients applicable to the aspheric surfaces in Embodiment 13. Here, the surface type of each aspheric surface may be defined using the formula (1) given in Embodiment 1.

TABLE 25

| | radius of | thickness d/ | | |
|---|---|---|---|---|
| surface | curvature | distance Tᵢ | refractive | abbe number |
| number | R (mm) | (mm) | index Nd | Vd |
| S1 | 5.2405 | 1.2944 | 1.81 | 41.00 |
| S2 | 2.6997 | 3.0000 | | |
| S3 | −6.6136 | 6.2507 | 1.80 | 46.60 |
| S4 | −10.6186 | −0.5201 | | |
| STO | infinite | 1.3077 | | |
| S6 | 12.2414 | 5.7597 | 1.62 | 63.40 |
| S7 | −23.5614 | 1.8502 | | |
| S8 | 8.2205 | 5.8001 | 1.50 | 81.60 |
| S9 | −8.3503 | 1.0899 | 1.92 | 18.90 |
| S10 | −48.3658 | 0.9098 | | |
| S11 | 14.4837 | 3.6000 | 1.59 | 61.10 |
| S12 | −108.7709 | 0.6389 | | |
| S13 | infinite | 0.5500 | 1.52 | 64.20 |
| S14 | infinite | 2.3024 | | |
| IMA | / | / | | |

TABLE 26

| surface | | | | | | | | |
|---|---|---|---|---|---|---|---|---|
| number | k | A4 | A6 | A8 | A10 | A12 | A14 | A16 |
| S1 | −2.8683 | −1.8834E−03 | −2.8107E−05 | 4.6365E−06 | −8.4842E−08 | −2.6232E−09 | 8.2814E−11 | −3.2384E−14 |
| S2 | −3.3187 | 9.7947E−03 | −1.6058E−03 | 1.7203E−04 | −9.2526E−06 | 5.8829E−08 | 2.1181E−08 | −7.6159E−10 |
| S11 | −25.4081 | −4.8785E−05 | −7.5827E−05 | 2.7826E−06 | −1.1803E−07 | 9.1755E−11 | 1.3789E−10 | −3.1927E−12 |
| S12 | 220.0071 | −1.1229E−03 | −2.7046E−05 | 6.5460E−07 | 1.0098E−08 | −5.5358E−10 | 2.3125E−11 | −4.9086E−13 |

### Embodiment 14

An optical lens assembly according to Embodiment 14 of the present disclosure is described below with reference to FIG. 14. FIG. 14 is a schematic structural diagram of the optical lens assembly according to Embodiment 14 of the present disclosure.

As shown in FIG. 14, the optical lens assembly includes, sequentially along an optical axis from an object side to an image side, a first lens L1, a second lens L2, a third lens L3, a fourth lens L4, a fifth lens L5, and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 27 shows a radius of curvature R, a thickness d/distance Tᵢ, a refractive index Nd and an abbe number Vd of each lens of the optical lens assembly in Embodiment 14. Table 28 shows the conic coefficients and the high-order coefficients applicable to the aspheric surfaces in Embodiment 14. Here, the surface type of each aspheric surface may be defined using the formula (1) given in Embodiment 1.

TABLE 27

| | radius of | thickness d/ | | |
|---|---|---|---|---|
| surface | curvature | distance Tᵢ | refractive | abbe number |
| number | R (mm) | (mm) | index Nd | Vd |
| S1 | 5.3457 | 1.0000 | 1.81 | 41.00 |
| S2 | 2.9193 | 2.9200 | | |
| S3 | −8.9323 | 6.2100 | 1.80 | 46.60 |
| S4 | −13.0722 | −0.4000 | | |
| STO | infinite | 4.2704 | | |
| S6 | 11.0341 | 5.7043 | 1.69 | 54.60 |
| S7 | −46.6604 | 0.4357 | | |
| S8 | 8.0817 | 5.6025 | 1.50 | 81.60 |
| S9 | −8.0817 | 1.0000 | 1.95 | 17.90 |
| S10 | −47.7338 | 0.5572 | | |
| S11 | 14.2625 | 3.4290 | 1.59 | 61.10 |
| S12 | 25.8297 | 0.8500 | | |
| S13 | infinite | 0.5500 | 1.52 | 64.20 |
| S14 | infinite | 2.2383 | | |
| IMA | / | / | | |

TABLE 28

| surface | | | | | | | | |
|---|---|---|---|---|---|---|---|---|
| number | k | A4 | A6 | A8 | A10 | A12 | A14 | A16 |
| S1 | −1.1910 | −5.2279E−03 | 1.0345E−04 | 6.6236E−06 | −4.6466E−07 | 7.4740E−09 | 1.5865E−10 | −4.7454E−12 |
| S2 | −2.2076 | −8.8807E−04 | −1.0929E−06 | −2.0625E−05 | 7.6994E−06 | −8.9166E−07 | 4.7211E−08 | −9.6242E−10 |
| S11 | 6.9600 | −1.8143E−03 | 3.0319E−06 | −5.1626E−06 | 5.3036E−07 | −3.3402E−08 | 1.2874E−09 | −2.1499E−13 |
| S12 | −35.0938 | −1.1433E−03 | −1.8268E−05 | −8.0006E−07 | 2.6696E−07 | −1.8105E−08 | 6.6944E−10 | −1.0096E−11 |

### Embodiment 15

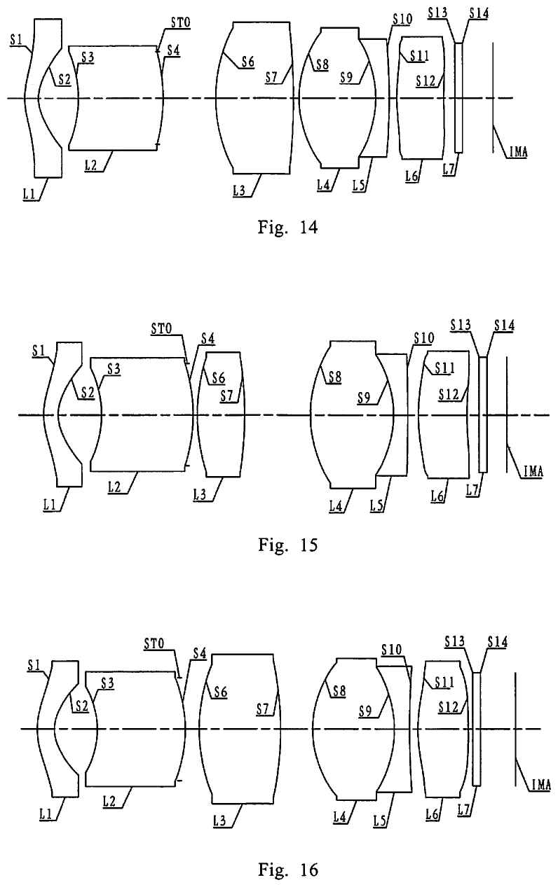

An optical lens assembly according to Embodiment 15 of the present disclosure is described below with reference to FIG. 15. FIG. 15 is a schematic structural diagram of the optical lens assembly according to Embodiment 15 of the present disclosure.

As shown in FIG. 15, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 29 shows a radius of curvature R, a thickness d/distance Tᵢ, a refractive index Nd and an abbe number Vd of each lens of the optical lens assembly in Embodiment 15. Table 30 shows the conic coefficients and the high-order coefficients applicable to the aspheric surfaces in Embodiment 15. Here, the surface type of each aspheric surface may be defined using the formula (1) given in Embodiment 1.

TABLE 29

| | radius of | thickness d/ | | |
|---|---|---|---|---|
| surface | curvature | distance Tᵢ | refractive | abbe number |
| number | R (mm) | (mm) | index Nd | Vd |
| S1 | 4.9607 | 1.0000 | 1.85 | 40.10 |
| S2 | 2.8291 | 3.0213 | | |
| S3 | −7.3851 | 6.3847 | 1.80 | 46.60 |
| S4 | −11.4856 | −0.4000 | | |
| STO | infinite | 0.7005 | | |
| S6 | 13.0765 | 3.3114 | 1.59 | 68.50 |
| S7 | −25.9477 | 4.6115 | | |
| S8 | 8.9079 | 5.7811 | 1.69 | 54.57 |
| S9 | −7.7441 | 1.0000 | 1.92 | 18.90 |
| S10 | −141.8945 | 0.7340 | | |
| S11 | 11.8290 | 3.4038 | 1.59 | 61.20 |
| S12 | 19.3758 | 0.8500 | | |
| S13 | infinite | 0.5500 | 1.52 | 64.20 |
| S14 | infinite | 1.3869 | | |
| IMA | / | / | | |

TABLE 30

| surface | | | | | | | | |
|---|---|---|---|---|---|---|---|---|
| number | k | A4 | A6 | A8 | A10 | A12 | A14 | A16 |
| S1 | −0.7248 | −4.8667E−03 | 6.7192E−05 | 6.1229E−06 | −4.1077E−07 | 7.0790E−09 | 1.3952E−10 | −4.7194E−12 |
| S2 | −1.9054 | −7.7911E−04 | 4.6417E−05 | −2.4035E−05 | 7.3214E−06 | −8.4390E−07 | 4.6130E−08 | −9.8152E−10 |
| S11 | 4.6316 | −1.2820E−03 | −6.5781E−06 | −4.2935E−06 | 5.1124E−07 | −3.5017E−08 | 1.2955E−09 | −2.0193E−12 |
| S12 | −45.1848 | −2.4643E−04 | −4.5618E−05 | −1.3746E−06 | 3.1444E−07 | −1.8175E−08 | 5.7846E−10 | −6.7103E−12 |

### Embodiment 16

An optical lens assembly according to Embodiment 16 of the present disclosure is described below with reference to FIG. 16. FIG. 16 is a schematic structural diagram of the optical lens assembly according to Embodiment 16 of the present disclosure.

As shown in FIG. 16, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a dual-concave lens having a negative refractive power, an object-side surface S9 of the fifth lens L5 is a concave surface, and an image-side surface S10 of the fifth lens L5 is a concave surface. The sixth lens L6 is a dual-convex lens having a positive refractive power, an object-side surface S11 of the sixth lens L6 is a convex surface, and an image-side surface S12 of the sixth lens L6 is a convex surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 31 shows a radius of curvature R, a thickness d/distance Tᵢ, a refractive index Nd and an abbe number Vd of each lens of the optical lens assembly in Embodiment 16. Table 32 shows the conic coefficients and the high-order coefficients applicable to the aspheric surfaces in Embodiment 16. Here, the surface type of each aspheric surface may be defined using the formula (1) given in Embodiment 1.

TABLE 31

| | radius of | thickness d/ | | |
|---|---|---|---|---|
| surface | curvature | distance Tᵢ | refractive | abbe number |
| number | R (mm) | (mm) | index Nd | Vd |
| S1 | 4.9935 | 1.2190 | 1.81 | 41.00 |
| S2 | 2.7007 | 3.0503 | | |
| S3 | −6.2240 | 6.2571 | 1.80 | 46.60 |
| S4 | −10.1384 | −0.4000 | | |
| STO | infinite | 1.4055 | | |
| S6 | 12.3645 | 5.8009 | 1.62 | 63.40 |
| S7 | −23.9023 | 2.3135 | | |
| S8 | 7.6206 | 5.8019 | 1.50 | 81.60 |
| S9 | −8.5299 | 1.0899 | 1.92 | 18.90 |
| S10 | 60.0000 | 0.5941 | | |
| S11 | 10.7597 | 3.6000 | 1.68 | 30.00 |
| S12 | −68.4190 | 0.3258 | | |
| S13 | infinite | 0.5500 | 1.52 | 64.20 |
| S14 | infinite | 2.4911 | | |
| IMA | / | / | | |

TABLE 32

| surface | | | | | | | | |
|---|---|---|---|---|---|---|---|---|
| number | k | A4 | A6 | A8 | A10 | A12 | A14 | A16 |
| S1 | −4.8601 | 3.0489E−05 | −1.4141E−04 | 8.7090E−06 | −1.5867E−07 | −2.4566E−09 | 9.5805E−11 | −1.1129E−13 |
| S2 | −3.7874 | 1.1463E−02 | −1.7726E−03 | 1.7774E−04 | −8.8882E−06 | 5.1953E−08 | 1.6661E−08 | −4.8092E−10 |
| S11 | −2.2075 | −6.5114E−04 | −2.3336E−05 | 8.9909E−07 | −8.8769E−08 | 7.5144E−10 | 1.4236E−10 | −3.1979E−13 |
| S12 | 99.9989 | −7.0649E−04 | −1.7040E−05 | −4.5888E−07 | 2.9101E−08 | −3.9155E−10 | 2.7461E−11 | −7.2385E−13 |

### Embodiment 17

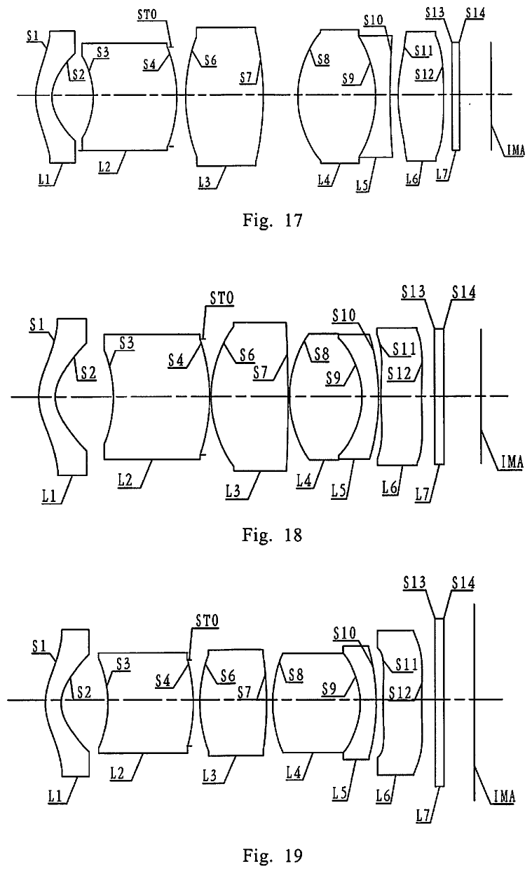

An optical lens assembly according to Embodiment 17 of the present disclosure is described below with reference to FIG. 17. FIG. 17 is a schematic structural diagram of the optical lens assembly according to Embodiment 17 of the present disclosure.

As shown in FIG. 17, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a dual-concave lens having a negative refractive power, an object-side surface S9 of the fifth lens L5 is a concave surface, and an image-side surface S10 of the fifth lens L5 is a concave surface. The sixth lens L6 is a dual-convex lens having a positive refractive power, an object-side surface S 11 of the sixth lens L6 is a convex surface, and an image-side surface S12 of the sixth lens L6 is a convex surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 33 shows a radius of curvature R, a thickness d/distance Tᵢ, a refractive index Nd and an abbe number Vd of each lens of the optical lens assembly in Embodiment 17. Table 34 shows the conic coefficients and the high-order coefficients applicable to the aspheric surfaces in Embodiment 17. Here, the surface type of each aspheric surface may be defined using the formula (1) given in Embodiment 1.

TABLE 33

| | radius of | thickness d/ | | |
|---|---|---|---|---|
| surface | curvature | distance Tᵢ | refractive | abbe number |
| number | R (mm) | (mm) | index Nd | Vd |
| S1 | 4.9915 | 1.2190 | 1.81 | 41.00 |
| S2 | 2.6916 | 3.0662 | | |
| S3 | −6.1961 | 6.2596 | 1.80 | 46.60 |
| S4 | −10.1611 | −0.4000 | | |
| STO | infinite | 1.0718 | | |
| S6 | 12.7636 | 5.8015 | 1.60 | 65.50 |
| S7 | −21.2748 | 2.6237 | | |
| S8 | 7.6753 | 5.8031 | 1.50 | 81.60 |
| S9 | −8.7460 | 1.0899 | 1.92 | 18.90 |
| S10 | 59.9999 | 0.5932 | | |
| S11 | 10.5381 | 3.4151 | 1.68 | 30.00 |
| S12 | −63.9311 | 0.6389 | | |
| S13 | infinite | 0.5500 | 1.52 | 64.20 |
| S14 | infinite | 2.3678 | | |
| IMA | / | / | | |

TABLE 34

| surface | | | | | | | | |
|---|---|---|---|---|---|---|---|---|
| number | k | A4 | A6 | A8 | A10 | A12 | A14 | A16 |
| S1 | −4.6304 | −2.1809E−04 | −1.1475E−04 | 7.4248E−06 | −1.3427E−07 | −2.4151E−09 | 9.3783E−11 | −2.3864E−13 |
| S2 | −3.6637 | 1.0986E−02 | −1.6627E−03 | 1.6708E−04 | −8.3717E−06 | 5.6536E−08 | 1.4834E−08 | −4.0899E−10 |
| S11 | −1.5256 | −6.2295E−04 | −2.3902E−05 | 1.2130E−06 | −9.7335E−08 | 6.8988E−10 | 1.2896E−10 | −2.7777E−13 |
| S12 | 100.0001 | −6.3959E−04 | −6.7073E−06 | −1.0474E−06 | 4.2501E−08 | −5.9504E−10 | 2.5311E−11 | −6.0430E−13 |

### Embodiment 18

An optical lens assembly according to Embodiment 18 of the present disclosure is described below with reference to FIG. 18. FIG. 18 is a schematic structural diagram of the optical lens assembly according to Embodiment 18 of the present disclosure.

As shown in FIG. 18, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 35 shows a radius of curvature R, a thickness d/distance Tᵢ, a refractive index Nd and an abbe number Vd of each lens of the optical lens assembly in Embodiment 18. Table 36 shows the conic coefficients and the high-order coefficients applicable to the aspheric surfaces in Embodiment 18. Here, the surface type of each aspheric surface may be defined using the formula (1) given in Embodiment 1.

TABLE 35

| | radius of | thickness d/ | | |
|---|---|---|---|---|
| surface | curvature | distance Tᵢ | refractive | abbe number |
| number | R (mm) | (mm) | index Nd | Vd |
| S1 | 3.4597 | 1.0000 | 1.81 | 41.00 |
| S2 | 2.0964 | 3.4758 | | |
| S3 | −7.5573 | 5.8015 | 1.91 | 35.30 |
| S4 | −10.5627 | −0.4000 | | |
| STO | infinite | 0.5000 | | |
| S6 | 7.2493 | 4.6180 | 1.62 | 63.40 |
| S7 | −94.7180 | 0.1000 | | |
| S8 | 6.7561 | 4.3338 | 1.44 | 94.58 |
| S9 | −5.1360 | 1.0000 | 1.92 | 18.90 |
| S10 | −13.1262 | 0.1470 | | |
| S11 | 22.3520 | 2.4368 | 1.59 | 61.20 |
| S12 | 30.3856 | 0.8000 | | |
| S13 | infinite | 0.5500 | 1.52 | 64.20 |
| S14 | infinite | 2.2356 | | |
| IMA | / | / | | |

TABLE 36

| surface | | | | | | | | |
|---|---|---|---|---|---|---|---|---|
| number | k | A4 | A6 | A8 | A10 | A12 | A14 | A16 |
| S1 | −2.7119 | 3.8494E−04 | −7.9371E−04 | 8.8498E−05 | −4.9077E−06 | 1.4449E−07 | −1.8354E−09 | 1.7683E−12 |
| S2 | −0.9362 | −7.6286E−03 | −4.8761E−04 | 4.3451E−05 | 1.4969E−05 | −2.8867E−06 | 2.0406E−07 | −5.2586E−09 |
| S11 | −23.7024 | −2.5375E−03 | 6.4591E−05 | −1.0236E−05 | −7.0187E−07 | 2.2417E−07 | −1.5753E−08 | 3.8104E−10 |
| S12 | −150.4486 | −1.4857E−03 | −8.6687E−06 | −2.7297E−06 | 2.3326E−07 | 2.3623E−09 | −5.9068E−10 | 1.5432E−12 |

### Embodiment 19

An optical lens assembly according to Embodiment 19 of the present disclosure is described below with reference to FIG. 19. FIG. 19 is a schematic structural diagram of the optical lens assembly according to Embodiment 19 of the present disclosure.

As shown in FIG. 19, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 37 shows a radius of curvature R, a thickness d/distance Tᵢ, a refractive index Nd and an abbe number Vd of each lens of the optical lens assembly in Embodiment 19. Table 38 shows the conic coefficients and the high-order coefficients applicable to the aspheric surfaces in Embodiment 19. Here, the surface type of each aspheric surface may be defined using the formula (1) given in Embodiment 1.

TABLE 37

| | radius of | thickness d/ | | |
|---|---|---|---|---|
| surface | curvature | distance Tᵢ | refractive | abbe number |
| number | R (mm) | (mm) | index Nd | Vd |
| S1 | 3.6249 | 1.0000 | 1.81 | 41.00 |
| S2 | 2.1238 | 2.8948 | | |
| S3 | −7.2440 | 5.3248 | 1.80 | 46.60 |
| S4 | −10.4890 | −0.2500 | | |
| STO | infinite | 0.6789 | | |
| S6 | 8.8227 | 4.1455 | 1.62 | 63.40 |
| S7 | −23.1045 | 0.3947 | | |
| S8 | 7.8379 | 5.4639 | 1.50 | 81.60 |
| S9 | −5.1360 | 1.0000 | 1.92 | 18.90 |
| S10 | −12.9533 | 0.4331 | | |
| S11 | 26.1869 | 2.4000 | 1.59 | 61.10 |
| S12 | 28.2075 | 0.8500 | | |
| S13 | infinite | 0.5500 | 1.52 | 64.20 |
| S14 | infinite | 1.8971 | | |
| IMA | / | / | | |

TABLE 38

| surface | | | | | | | | |
|---|---|---|---|---|---|---|---|---|
| number | k | A4 | A6 | A8 | A10 | A12 | A14 | A16 |
| S1 | −3.2110 | 7.2167E−04 | −7.9505E−04 | 8.8089E−05 | −4.9103E−06 | 1.4558E−07 | −1.8257E−09 | 0.0000E+00 |
| S2 | −0.9271 | −7.5142E−03 | −3.8814E−04 | 3.5365E−05 | 1.4464E−05 | −2.8024E−06 | 2.1105E−07 | −5.9888E−09 |
| S11 | −11.2135 | −2.3896E−03 | 3.2661E−05 | −1.0076E−05 | −2.8386E−07 | 2.1576E−07 | −1.9269E−08 | 5.6615E−11 |
| S12 | −33.4982 | −2.0530E−03 | −3.3612E−05 | −5.1136E−08 | 1.6524E−07 | −2.4643E−09 | −1.8630E−10 | 6.4257E−12 |

### Embodiment 20

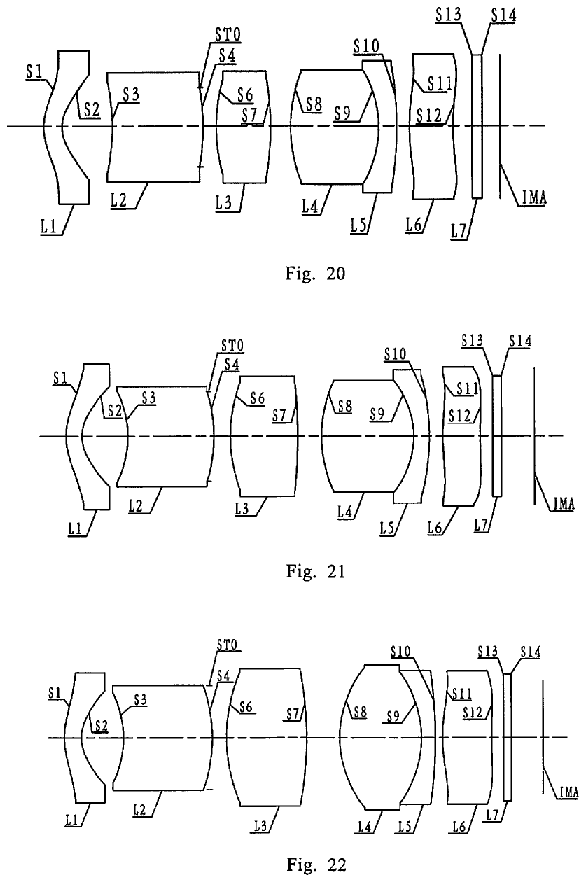

An optical lens assembly according to Embodiment 20 of the present disclosure is described below with reference to FIG. 20. FIG. 20 is a schematic structural diagram of the optical lens assembly according to Embodiment 20 of the present disclosure.

As shown in FIG. 20, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a positive refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 39 shows a radius of curvature R, a thickness d/distance Tᵢ, a refractive index Nd and an abbe number Vd of each lens of the optical lens assembly in Embodiment 20. Table 40 shows the conic coefficients and the high-order coefficients applicable to the aspheric surfaces in Embodiment 20. Here, the surface type of each aspheric surface may be defined using the formula (1) given in Embodiment 1.

TABLE 39

| | radius of | thickness d/ | | |
|---|---|---|---|---|
| surface | curvature | distance Tᵢ | refractive | abbe number |
| number | R (mm) | (mm) | index Nd | Vd |
| S1 | 3.2950 | 1.0000 | 1.81 | 41.00 |
| S2 | 1.9471 | 2.7579 | | |
| S3 | −12.1995 | 5.0000 | 1.80 | 46.60 |
| S4 | −12.1995 | −0.1500 | | |
| STO | infinite | 0.8801 | | |
| S6 | 9.5974 | 3.0000 | 1.62 | 63.40 |
| S7 | −16.0026 | 1.1096 | | |
| S8 | 8.2396 | 4.8517 | 1.50 | 81.60 |
| S9 | −6.0417 | 1.0000 | 1.92 | 18.90 |
| S10 | −19.5469 | 0.7075 | | |
| S11 | 13.6573 | 2.4000 | 1.59 | 61.20 |
| S12 | 15.6463 | 1.0479 | | |
| S13 | infinite | 0.5500 | 1.52 | 64.20 |
| S14 | infinite | 1.0000 | | |
| IMA | / | / | | |

TABLE 40

| surface | | | | | | | | |
|---|---|---|---|---|---|---|---|---|
| number | k | A4 | A6 | A8 | A10 | A12 | A14 | A16 |
| S1 | −1.1632 | −5.1002E−03 | −9.2807E−04 | 1.3027E−04 | −7.3684E−06 | 2.0215E−07 | −2.1463E−09 | −2.7326E−13 |
| S2 | −0.6753 | −1.4148E−02 | −1.9301E−03 | 2.9068E−04 | −7.1438E−06 | −2.6356E−06 | 2.8490E−07 | −1.0983E−08 |
| S11 | −20.6271 | 2.3465E−03 | −4.7845E−04 | 2.3847E−05 | −1.1986E−06 | 1.7531E−07 | −1.5844E−08 | 4.8104E−10 |
| S12 | 3.7432 | 9.2818E−04 | −3.3182E−04 | 1.7381E−06 | 9.8904E−07 | −3.3830E−08 | −9.2862E−10 | 4.9662E−11 |

### Embodiment 21

An optical lens assembly according to Embodiment 21 of the present disclosure is described below with reference to FIG. 21. FIG. 21 is a schematic structural diagram of the optical lens assembly according to Embodiment 21 of the present disclosure.

As shown in FIG. 21, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 41 shows a radius of curvature R, a thickness d/distance Tᵢ, a refractive index Nd and an abbe number Vd of each lens of the optical lens assembly in Embodiment 21. Table 42 shows the conic coefficients and the high-order coefficients applicable to the aspheric surfaces in Embodiment 21. Here, the surface type of each aspheric surface may be defined using the formula (1) given in Embodiment 1.

TABLE 41

| | radius of | thickness d/ | | |
|---|---|---|---|---|
| surface | curvature | distance Tᵢ | refractive | abbe number |
| number | R (mm) | (mm) | index Nd | Vd |
| S1 | 4.0406 | 1.0131 | 1.81 | 41.00 |
| S2 | 2.3471 | 2.9165 | | |
| S3 | −6.4985 | 5.4700 | 1.80 | 46.60 |
| S4 | −9.5871 | −0.3300 | | |
| STO | infinite | 1.3808 | | |
| S6 | 9.8197 | 4.2858 | 1.62 | 63.40 |
| S7 | −33.4567 | 1.5348 | | |
| S8 | 8.2872 | 5.8500 | 1.50 | 81.60 |
| S9 | −5.6039 | 1.0000 | 1.92 | 18.90 |
| S10 | −15.0011 | 0.8760 | | |
| S11 | 17.7866 | 2.3730 | 1.68 | 31.10 |
| S12 | 31.4266 | 0.7960 | | |
| S13 | infinite | 0.5500 | 1.52 | 64.20 |
| S14 | infinite | 2.1109 | | |
| IMA | / | / | | |

TABLE 42

| surface | | | | | | | | |
|---|---|---|---|---|---|---|---|---|
| number | k | A4 | A6 | A8 | A10 | A12 | A14 | A16 |
| S1 | −3.6820 | 8.3543E−04 | −5.3463E−04 | 5.2581E−05 | −2.6479E−06 | 7.4250E−08 | −1.0215E−09 | 3.7085E−12 |
| S2 | −0.8761 | −5.9586E−03 | −2.3601E−04 | 1.6199E−05 | 7.6983E−06 | −1.3128E−06 | 9.7967E−08 | −2.9906E−09 |
| S11 | 4.4905 | −1.4489E−03 | −2.5005E−05 | −9.1377E−07 | −4.5523E−07 | 8.8298E−08 | −5.2977E−09 | 1.1035E−10 |
| S12 | 38.1720 | −1.3382E−03 | −6.2664E−05 | −6.2631E−07 | 2.0950E−07 | −2.6310E−10 | −4.5792E−10 | 1.1051E−11 |

### Embodiment 22

An optical lens assembly according to Embodiment 22 of the present disclosure is described below with reference to FIG. 22. FIG. 22 is a schematic structural diagram of the optical lens assembly according to Embodiment 22 of the present disclosure.

As shown in FIG. 22, the optical lens assembly includes, sequentially along an optical axis from an object side to an image side, a first lens L1, a second lens L2, a third lens L3, a fourth lens L4, a fifth lens L5 and a sixth lens L6.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S6 of the third lens L3 is a convex surface, and an image-side surface S7 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a concave-convex lens having a negative refractive power, an object-side surface S9 of the fifth lens L5 is a concave surface, and an image-side surface S10 of the fifth lens L5 is a convex surface. The sixth lens L6 is a convex-concave lens having a positive refractive power, an object-side surface S11 of the sixth lens L6 is a convex surface, and an image-side surface S12 of the sixth lens L6 is a concave surface. The fourth lens L4 and the fifth lens L5 can be cemented to form a cemented lens.

The optical lens assembly may further include a diaphragm STO, and the diaphragm STO may be disposed between the second lens L2 and the third lens L3 to improve the imaging quality. For example, the diaphragm STO may be disposed at a position near the image-side surface S4 of the second lens L2 between the second lens L2 and the third lens L3.

Alternatively, the optical lens assembly may further include an optical filter L7 having an object-side surface S13 and an image-side surface S14 and/or a protective glass L7′. The optical filter L7 and/or the protective glass L7′ may be used to correct color deviations and/or protect an image sensing chip IMA at an image plane. Light from an object sequentially passes through the surfaces S1-S14 and finally forms an image on the image plane.

Table 43 shows a radius of curvature R, a thickness d/distance Tᵢ, a refractive index Nd and an abbe number Vd of each lens of the optical lens assembly in Embodiment 22. Table 44 shows the conic coefficients and the high-order coefficients applicable to the aspheric surfaces in Embodiment 22. Here, the surface type of each aspheric surface may be defined using the formula (1) given in Embodiment 1.

TABLE 43

| | radius of | thickness d/ | | |
|---|---|---|---|---|
| surface | curvature | distance Tᵢ | refractive | abbe number |
| number | R (mm) | (mm) | index Nd | Vd |
| S1 | 5.7000 | 1.2120 | 1.81 | 41.00 |
| S2 | 2.8658 | 2.9891 | | |
| S3 | −7.4600 | 6.3300 | 1.80 | 46.60 |
| S4 | −11.4970 | −0.2000 | | |
| STO | infinite | 1.2260 | | |
| S6 | 12.0780 | 5.7100 | 1.62 | 63.40 |
| S7 | −26.6554 | 2.3940 | | |
| S8 | 8.0667 | 5.8100 | 1.50 | 81.60 |
| S9 | −8.0667 | 1.0000 | 1.92 | 18.90 |
| S10 | −34.5000 | 0.5193 | | |
| S11 | 12.2762 | 3.5000 | 1.59 | 61.20 |
| S12 | 37.2997 | 0.8500 | | |
| S13 | infinite | 0.5500 | 1.52 | 64.20 |
| S14 | infinite | 2.2731 | | |
| IMA | / | / | | |

TABLE 44

| surface | | | | | | | | |
|---|---|---|---|---|---|---|---|---|
| number | k | A4 | A6 | A8 | A10 | A12 | A14 | A16 |
| S1 | −0.4253 | −4.0491E−03 | 1.8542E−05 | 6.9041E−06 | −3.9491E−07 | 6.8448E−09 | 1.0754E−10 | −3.9226E−12 |
| S2 | −1.5465 | −1.3324E−03 | 3.8037E−05 | −1.3031E−05 | 6.3652E−06 | −9.2093E−07 | 6.1202E−08 | −1.5435E−09 |
| S11 | 4.3957 | −1.3201E−03 | 4.1010E−06 | −5.4743E−06 | 5.5592E−07 | −3.4148E−08 | 1.1397E−09 | −1.5678E−11 |
| S12 | −70.9043 | −5.2664E−04 | −4.2045E−05 | −1.4767E−06 | 3.1904E−07 | −1.9163E−08 | 5.9565E−10 | −7.5612E−12 |

In summary, Embodiments 1-11 respectively satisfy the relationships shown in the following tables 45-1 and 45-2. In Tables 45-1 and 45-2, the units of TTL, F, H, D, d8i, F45, F1, F2, F3, F4, F5, F6, BFL, d23, R1, R3, R4, R8, R10, R11, R12, T2, T3, T4 and T5 are millimeters (mm), the unit of FOV is degrees)(°), and the unit of θ is radians (rad).

TABLE 45-1

| Conditional expression/ | | | | | | |
|---|---|---|---|---|---|---|
| Embodiment | Embodiment 1 | Embodiment 2 | Embodiment 3 | Embodiment 4 | Embodiment 5 | Embodiment 6 |
| TTL | 27.02 | 26.50 | 26.48 | 25.48 | 26.18 | 27.00 |
| F | 5.09 | 5.08 | 5.08 | 5.09 | 5.10 | 5.10 |
| H | 8.06 | 8.06 | 8.06 | 8.06 | 8.06 | 8.06 |
| FOV | 120 | 120 | 120 | 120 | 120 | 120 |
| θ | 2.09 | 2.09 | 2.09 | 2.09 | 2.09 | 2.09 |
| D | 8.43 | 8.43 | 8.43 | 8.50 | 8.90 | 8.61 |
| d8i | 12.48 | 12.10 | 11.66 | 11.85 | 12.92 | 13.52 |
| F45 | 18.24 | 15.09 | 14.75 | 10.45 | 29.07 | 13.00 |
| F1 | −9.26 | −8.76 | −8.67 | −9.00 | −7.21 | −8.15 |
| F2 | −107.11 | −313.27 | 428.91 | −187.25 | 26.69 | −97.71 |
| F3 | 10.89 | 11.50 | 11.11 | 11.53 | 12.50 | 14.07 |
| F4 | 7.22 | 6.75 | 6.61 | −11.98 | −12.16 | −14.42 |
| F5 | −9.82 | −10.36 | −10.71 | 5.14 | 7.36 | 5.61 |
| F6 | −854.09 | −233.76 | −63.81 | −21.86 | −73.83 | −89.09 |
| dn/dt(3) | −1.07E−05 | −1.07E−05 | −1.07E−05 | −1.07E−05 | −2.02E−05 | −2.02E−05 |
| dn/dt(4) | −2.02E−05 | −2.02E−05 | −2.02E−05 | −5.40E−06 | −5.40E−06 | −5.40E−06 |
| dn/dt(5) | −5.40E−06 | −5.40E−06 | −5.40E−06 | −2.02E−05 | −2.02E−05 | −2.02E−05 |
| FNO | 1.80 | 1.80 | 1.80 | 1.80 | 1.80 | 1.80 |
| BFL | 3.29 | 3.30 | 3.30 | 3.29 | 2.71 | 4.21 |
| K2 | 0.97 | 0.96 | 0.95 | 0.94 | 0.91 | 0.92 |
| K11 | −4.72 | −3.49 | −2.59 | −1.31 | −9.12 | −3.77 |
| K12 | −4.45 | −2.89 | −2.29 | −1.01 | −2.29 | −1.40 |
| TTL/F | 5.31 | 5.22 | 5.21 | 5.00 | 5.14 | 5.30 |
| TTL/H/FOV | 0.0279 | 0.0274 | 0.0274 | 0.0263 | 0.0271 | 0.0279 |
| D/H/FOV | 0.0087 | 0.0087 | 0.0087 | 0.0088 | 0.0092 | 0.0089 |
| F45/F | 3.58 | 2.97 | 2.90 | 2.05 | 5.70 | 2.55 |
| arctan(1/K2) | 46.01 | 46.10 | 46.51 | 46.70 | 47.81 | 47.39 |
| (FOV × F)/H | 75.75 | 75.60 | 75.59 | 75.80 | 75.86 | 75.85 |
| d8i/TTL | 0.462 | 0.457 | 0.440 | 0.465 | 0.493 | 0.501 |
| T2/TTL | 0.196 | 0.204 | 0.212 | 0.215 | 0.201 | 0.204 |
| \|R4/(\|R3\| + T2)\| | 0.84 | 0.78 | 0.74 | 0.80 | 0.47 | 0.87 |
| Tn1/Tm2(n1 and m1 = 2, 3, 4) | 1.25 | 1.43 | 1.47 | / | / | / |
| Tn2/Tm2(n2 and m2 = 2, 3, 5) | / | / | / | 1.33 | 1.63 | 1.64 |
| Nd1/Nd2 | 1.00 | 1.00 | 1.00 | 0.96 | 1.00 | 0.94 |
| \|F3/F5\| | / | / | / | 2.24 | 1.70 | 2.51 |
| \|F3/F4\| | 1.51 | 1.70 | 1.68 | / | / | / |
| (F3 + F4)/(dn/dt(3) + dn/dt(4)) | −5.86E+05 | −5.91E+05 | −5.73E+05 | / | / | / |
| (F3 + F5)/(dn/dt(3) + dn/dt(5)) | / | / | / | −5.39E+05 | −4.92E+05 | −4.87E+05 |
| (H − F × θ)/(F × θ) | −0.24 | −0.24 | −0.24 | −0.24 | −0.24 | −0.24 |
| FNO/F | 0.35 | 0.35 | 0.35 | 0.35 | 0.35 | 0.35 |
| \|F4/F5\| | 0.74 | 0.65 | 0.62 | 2.33 | 1.65 | 2.57 |
| \|F3/F\| | 2.14 | 2.26 | 2.19 | 2.26 | 2.45 | 2.76 |
| BFL/TTL | 0.12 | 0.12 | 0.12 | 0.13 | 0.10 | 0.16 |
| d23/TTL | 0.11 | 0.11 | 0.11 | 0.08 | 0.08 | 0.09 |
| F1/F | −1.82 | −1.73 | −1.71 | −1.77 | −1.41 | −1.60 |
| R10/F | −2.54 | −2.11 | −1.82 | −1.28 | −3.67 | −2.13 |
| \|F6/F\| | 167.78 | 46.01 | 12.56 | 4.29 | 14.48 | 17.48 |
| arctan(1/K11) | −11.95 | −16.00 | −21.08 | −37.34 | −6.26 | −14.87 |
| arctan(1/K12) | −12.65 | −19.10 | −23.63 | −44.71 | −23.56 | −35.54 |

TABLE 45-2

| Conditional | Embodiment | | | | |
|---|---|---|---|---|---|
| expression | Embodiment 7 | Embodiment 8 | Embodiment 9 | Embodiment 10 | Embodiment 11 |
| TTL | 31.78 | 33.10 | 26.81 | 24.62 | 32.00 |
| F | 5.04 | 5.07 | 5.00 | 4.99 | 5.00 |
| H | 8.06 | 8.06 | 8.06 | 8.06 | 8.06 |
| FOV | 120 | 120 | 120 | 120 | 120 |
| θ | 2.09 | 2.09 | 2.09 | 2.09 | 2.09 |
| D | 9.00 | 9.04 | 9.28 | 8.85 | 9.00 |
| d8i | 14.64 | 14.00 | 11.41 | 10.49 | 15.28 |
| F45 | 23.45 | 20.21 | 20.18 | 19.11 | 38.18 |
| F1 | −7.17 | −6.94 | −6.74 | −6.31 | −7.77 |
| F2 | 25.62 | 22.81 | 21.53 | 137.42 | 29.17 |
| F3 | 15.42 | 16.68 | 14.71 | 8.67 | 16.45 |
| F4 | −13.19 | −15.34 | 5.93 | 4.79 | −13.85 |
| F5 | 8.77 | 9.01 | −7.61 | −6.51 | 10.12 |
| F6 | 58.59 | 1639.48 | 721.18 | 8209.03 | 24.98 |
| dn/dt(3) | −1.07E−05 | −2.02E−05 | −1.07E−05 | −1.07E−05 | −1.07E−05 |
| dn/dt(4) | −6.93E−06 | −5.40E−06 | −1.07E−05 | −1.07E−05 | −6.93E−06 |
| dn/dt(5) | −2.02E−05 | −2.02E−05 | −6.93E−06 | −6.93E−06 | −2.02E−05 |
| FNO | 1.46 | 1.46 | 1.90 | 2.00 | 1.46 |
| BFL | 4.44 | 2.76 | 3.36 | 3.16 | 2.95 |
| K2 | 1.03 | 0.68 | 1.00 | 1.01 | 0.95 |
| K11 | −2.64 | −1.03 | −3.59 | −1.30 | 5.50 |
| K12 | −1.13 | −1.19 | −1.84 | −0.74 | −2.12 |
| TTL/F | 6.31 | 6.53 | 5.36 | 4.93 | 6.40 |
| TTL/H/FOV | 0.0328 | 0.0342 | 0.0277 | 0.0254 | 0.0331 |
| D/H/FOV | 0.0093 | 0.0093 | 0.0096 | 0.0091 | 0.0093 |
| F45/F | 4.66 | 3.98 | 4.04 | 3.83 | 7.64 |
| arctan(1/K2) | 44.05 | 55.97 | 45.11 | 44.86 | 46.58 |
| (FOV × F)/H | 74.93 | 75.48 | 74.40 | 74.26 | 74.40 |
| d8i/TTL | 0.461 | 0.423 | 0.426 | 0.426 | 0.478 |
| T2/TTL | 0.158 | 0.189 | 0.194 | 0.156 | 0.210 |
| \|R4/(\|R3\| + T2) | 0.56 | 0.45 | 0.53 | 0.74 | 0.56 |
| Tn1/Tm2(n1 and m1 = 2, 3, 4) | / | / | 1.82 | 1.36 | / |
| Tn2/Tm2(n2 and m2 = 2, 3, 5) | 1.75 | 1.13 | / | / | 2.00 |
| Nd1/Nd2 | 0.88 | 1.00 | 0.91 | 0.91 | 0.88 |
| \|F3/F5\| | 1.76 | 1.85 | / | / | 1.63 |
| \|F3/F4\| | / | / | 2.48 | 1.81 | 1.19 |
| (F3 + F4)/(dn/dt(3) + dn/dt(4)) | / | / | −9.65E+05 | −6.29E+05 | / |
| (F3 + F5)/(dn/dt(3) + dn/dt(5)) | −7.83E+05 | −6.36E+05 | / | / | / |
| (H − F × θ)/(F × θ) | −0.24 | −0.24 | −0.23 | −0.23 | −0.23 |
| FNO/F | 0.29 | 0.29 | 0.38 | 0.40 | 0.29 |
| \|F4/F5\| | 1.50 | 1.70 | 0.78 | 0.74 | 1.37 |
| \|F3/F\| | 3.06 | 3.29 | 2.94 | 1.74 | 3.29 |
| BFL/TTL | 0.15 | 0.08 | 0.13 | 0.13 | 0.09 |
| d23/TTL | 0.07 | 0.08 | 0.09 | 0.10 | 0.08 |
| F1/F | −1.42 | −1.37 | −1.35 | −1.26 | −1.55 |
| R10/F | −2.55 | −2.29 | −3.65 | −1.69 | −4.57 |
| \|F6/F\| | 11.64 | 323.23 | 144.24 | 1644.90 | 5.00 |
| arctan(1/K11) | −20.72 | −44.08 | −15.57 | −37.57 | 10.31 |
| arctan(1/K12) | −41.45 | −40.14 | −28.54 | −53.65 | −25.21 |

In summary, Embodiments 12-22 respectively satisfy the relationships shown in the following tables 46-1 and 46-2. In Tables 46-1 and 46-2, the units of TTL, F, H, D, D11, T₈₋ᵢ, T₈₋₁₁, T₃₋₁₃, d2, R3, R4, R6, R7, R8, R11, R12, SAG11, F45, F1, F2, F3, F4, F5 and F6 are millimeters (mm), the unit of FOV is degrees)(°), and the unit of θ is radians (rad).

TABLE 46-1

| Conditional | Embodiment | | | | |
|---|---|---|---|---|---|
| expression | Embodiment 12 | Embodiment 13 | Embodiment 14 | Embodiment 15 | Embodiment 16 |
| TTL | 34.137 | 33.834 | 34.367 | 32.335 | 34.099 |
| F | 5.063 | 5.070 | 5.114 | 5.074 | 5.070 |
| H | 8.064 | 8.064 | 8.064 | 8.064 | 8.064 |
| FOV | 120.000 | 120.000 | 120.000 | 120.000 | 120.000 |
| D | 9.000 | 9.000 | 9.712 | 9.000 | 9.000 |
| T8-i | 14.455 | 14.891 | 14.227 | 13.706 | 14.453 |
| T8-11 | 10.790 | 11.400 | 10.589 | 10.919 | 11.086 |
| T3-13 | 27.902 | 27.237 | 28.209 | 26.927 | 27.339 |
| D11/2 | 4.535 | 4.573 | 4.265 | 4.258 | 4.628 |
| SAG11 | 0.893 | −0.016 | 0.374 | 0.652 | 0.559 |
| F45 | 24.510 | 28.324 | 30.094 | 16.651 | 62.700 |
| F1 | −9.233 | −8.866 | −9.753 | −9.817 | −9.545 |
| F2 | −74.850 | −71.727 | −105.897 | −84.161 | −69.839 |
| F3 | 14.165 | 13.844 | 13.386 | 15.099 | 13.999 |
| F4 | 9.170 | 9.408 | 9.166 | 6.952 | 9.173 |
| F5 | −11.382 | −10.961 | −10.293 | −8.810 | −7.943 |
| F6 | 33.880 | 21.857 | 48.811 | 44.262 | 13.787 |
| dn3/dt3 | −1.07 × 10⁻⁵ | −1.07 × 10⁻⁵ | −5.27 × 10⁻⁶ | −1.96 × 10⁻⁵ | −1.07 × 10⁻⁵ |
| dn4/dt4 | −1.92 × 10⁻⁵ | −1.92 × 10⁻⁵ | −2.02 × 10⁻⁵ | −5.27 × 10⁻⁶ | −2.02 × 10⁻⁵ |
| FNO | 1.450 | 1.460 | 1.460 | 1.460 | 1.460 |
| K2 | 0.976 | 0.993 | 1.106 | 1.094 | 0.924 |
| K12 | −3.816 | −1.405 | −6.261 | −42.097 | −2.117 |
| TTL/F | 6.742 | 6.673 | 6.720 | 6.373 | 6.726 |
| TTL/H/FOV | 0.035 | 0.035 | 0.036 | 0.033 | 0.035 |
| D/H/FOV | 0.009 | 0.009 | 0.010 | 0.009 | 0.009 |
| (FOV × F)/H | 75.342 | 75.446 | 76.108 | 75.500 | 75.444 |
| F1/F | −1.824 | −1.749 | −1.907 | −1.935 | −1.883 |
| F3/F | 2.798 | 2.731 | 2.617 | 2.976 | 2.761 |
| R3/R4 | 0.636 | 0.623 | 0.683 | 0.643 | 0.614 |
| R3/(R4 + d2) | 1.393 | 1.514 | 1.302 | 1.448 | 1.604 |
| d2/TTL | 0.183 | 0.185 | 0.181 | 0.197 | 0.183 |
| R7/F | −5.219 | −4.647 | −9.123 | −5.114 | −4.715 |
| F45/F | 4.841 | 5.587 | 5.884 | 3.282 | 12.367 |
| F3/F4 | 1.545 | 1.471 | 1.460 | 2.172 | 1.526 |
| T8-11/R8 | 1.342 | 1.387 | 1.310 | 1.226 | 1.455 |
| T3-13/TTL | 0.817 | 0.805 | 0.821 | 0.833 | 0.802 |
| T8-i/TTL | 0.423 | 0.440 | 0.414 | 0.424 | 0.424 |
| Vd4/Vd5 | 4.317 | 4.317 | 4.559 | 2.887 | 4.317 |
| arctan(1/K2) | 45.688 | 45.190 | 42.108 | 42.432 | 47.255 |
| R11/F | 2.505 | 2.857 | 2.789 | 2.331 | 2.122 |
| \|SAG11/D11/2\| | 0.197 | 0.004 | 0.088 | 0.153 | 0.121 |
| arctan(1/K12) | −14.683 | −35.444 | −9.074 | −1.361 | −25.281 |
| (H/2)/(F × tan(θ/2)) | 0.460 | 0.460 | 0.456 | 0.459 | 0.460 |
| D/H/θ | 0.533 | 0.533 | 0.575 | 0.533 | 0.533 |

TABLE 46-2

| Conditional expression/ | Embodiment | Embodiment | Embodiment | Embodiment | Embodiment | Embodiment |
|---|---|---|---|---|---|---|
| Embodiment | 17 | 18 | 19 | 20 | 21 | 22 |
| TTL | 34.100 | 26.599 | 26.783 | 25.155 | 29.827 | 34.163 |
| F | 5.070 | 5.079 | 5.084 | 5.352 | 5.300 | 5.090 |
| H | 8.064 | 8.064 | 8.064 | 8.064 | 8.640 | 8.064 |
| FOV | 120.000 | 120.000 | 120.000 | 120.000 | 120.000 | 120.000 |
| D | 9.000 | 8.794 | 8.400 | 7.600 | 8.763 | 8.960 |
| T8-i | 14.458 | 11.503 | 12.594 | 11.557 | 13.556 | 14.502 |
| T8-11 | 10.901 | 7.918 | 9.297 | 8.959 | 10.099 | 10.829 |
| T3-13 | 27.447 | 19.887 | 20.991 | 20.397 | 23.786 | 27.689 |
| D11/2 | 4.680 | 3.730 | 3.453 | 3.552 | 4.020 | 5.060 |
| SAG11 | 0.625 | −0.222 | −0.355 | 0.209 | 0.005 | 0.317 |
| F45 | 61.300 | 21.837 | 18.562 | 24.474 | 20.717 | 24.354 |
| F1 | −9.470 | −9.828 | −8.982 | −8.806 | −9.451 | −8.805 |
| F2 | −66.731 | −364.992 | −108.683 | 82.412 | −119.733 | −87.853 |
| F3 | 14.092 | 11.088 | 10.831 | 10.126 | 12.720 | 14.206 |
| F4 | 9.296 | 7.497 | 7.239 | 7.884 | 7.800 | 9.196 |
| F5 | −8.119 | −9.728 | −9.709 | −9.707 | −10.093 | −11.493 |
| F6 | 13.417 | 129.759 | 431.630 | 126.240 | 55.663 | 29.590 |
| dn3/dt3 | −1.20 × 10⁻⁵ | −1.07 × 10⁻⁵ | −1.07 × 10⁻⁵ | −1.07 × 10⁻⁵ | −1.07 × 10⁻⁵ | −1.07 × 10⁻⁵ |
| dn4/dt4 | −2.02 × 10⁻⁵ | −2.25 × 10⁻⁵ | −2.02 × 10⁻⁵ | −2.02 × 10⁻⁵ | −2.02 × 10⁻⁵ | −1.92 × 10⁻⁵ |
| FNO | 1.460 | 1.460 | 1.820 | 2.100 | 1.830 | 1.467 |
| K2 | 0.904 | 0.957 | 0.966 | 1.330 | 0.978 | 1.026 |
| K12 | 2.129 | −2.000 | −2.430 | −2.914 | −1.145 | −2.878 |
| TTL/F | 6.726 | 5.237 | 5.268 | 4.700 | 5.628 | 6.712 |
| TTL/H/FOV | 0.035 | 0.027 | 0.028 | 0.026 | 0.029 | 0.035 |
| D/H/FOV | 0.009 | 0.009 | 0.009 | 0.008 | 0.008 | 0.009 |
| (FOV × F)/H | 75.442 | 75.582 | 75.656 | 79.635 | 73.611 | 75.739 |
| F1/F | −1.868 | −1.935 | −1.767 | −1.646 | −1.783 | −1.730 |
| F3/F | 2.780 | 2.183 | 2.130 | 1.892 | 2.400 | 2.791 |
| R3/R4 | 0.610 | 0.715 | 0.691 | 1.000 | 0.678 | 0.649 |
| R3/(R4 + d2) | 1.588 | 1.587 | 1.403 | 1.694 | 1.578 | 1.444 |
| d2/TTL | 0.184 | 0.218 | 0.199 | 0.199 | 0.183 | 0.185 |
| R7/F | −4.196 | −18.648 | −4.544 | −2.990 | −6.313 | −5.237 |
| F45/F | 12.091 | 4.299 | 3.651 | 4.573 | 3.909 | 4.785 |
| F3/F4 | 1.516 | 1.479 | 1.496 | 1.284 | 1.631 | 1.545 |
| T8-11/R8 | 1.420 | 1.172 | 1.186 | 1.087 | 1.219 | 1.342 |
| T3-13/TTL | 0.805 | 0.748 | 0.784 | 0.811 | 0.797 | 0.810 |
| T8-i/TTL | 0.424 | 0.432 | 0.470 | 0.459 | 0.454 | 0.425 |
| Vd4/Vd5 | 4.317 | 5.004 | 4.317 | 4.317 | 4.317 | 4.317 |
| arctan(1/K2) | 47.889 | 46.273 | 45.982 | 36.935 | 45.635 | 44.274 |
| R11/F | 2.079 | 4.401 | 5.151 | 2.552 | 3.356 | 2.412 |
| \|SAG11/D11/2\| | 0.134 | 0.060 | 0.103 | 0.059 | 0.001 | 0.063 |
| arctan(1/K12) | −25.160 | −26.569 | −22.364 | −18.940 | −41.122 | −19.158 |
| (H/2)/(F × tan(θ/2)) | 0.460 | 0.459 | 0.458 | 0.436 | 0.471 | 0.458 |
| D/H/θ | 0.533 | 0.521 | 0.498 | 0.450 | 0.485 | 0.531 |

The present disclosure further provides an electronic device, which may include the optical lens assembly according to the above embodiments of the present disclosure and an imaging element used to convert an optical image formed by the optical lens assembly into an electrical signal. The electronic device may be an independent electronic device such as a detection distance camera, or may be an imaging module integrated into, for example, a detection distance device. In addition, the electronic device may be an independent imaging device such as a vehicle-mounted camera, or may be an imaging module integrated into, for example, a driving assistance system.

The foregoing is only a description for the preferred embodiments of the present disclosure and the applied technical principles. It should be appreciated by those skilled in the art that the inventive scope of the present disclosure is not limited to the technical solution formed by the particular combination of the above technical features. The inventive scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical lens assembly, comprising, sequentially from an object side to an image side along an optical axis:
a first lens, having a negative refractive power, an image-side surface of the first lens being a concave surface;
a second lens, having a refractive power, an object-side surface of the second lens being a concave surface, and an image-side surface of the second lens being a convex surface;
a third lens, having a positive refractive power, an object-side surface of the third lens being a convex surface, and an image-side surface of the third lens being a convex surface;
a fourth lens, having a refractive power, an object-side surface of the fourth lens being a convex surface;
a fifth lens, having a refractive power; and
a sixth lens, having a refractive power,
wherein (H−F×θ)/(F×θ)≤−0.1,
θ is a radian of a maximal field-of-view of the optical lens assembly, F is a total effective focal length of the optical lens assembly, and H is an image height corresponding to the maximal field-of-view of the optical lens assembly.

2. The optical lens assembly according to claim 1, wherein an object-side surface of the first lens is a convex or concave surface.

3. The optical lens assembly according to claim 1, wherein an image-side surface of the fourth lens is a convex or concave surface.

4. The optical lens assembly according to claim 1, wherein,
an object-side surface of the fifth lens is a concave surface and an image-side surface of the fifth lens is a convex surface;
an object-side surface of the fifth lens is a concave surface and an image-side surface of the fifth lens is a concave surface; or
an object-side surface of the fifth lens is a convex surface and an image-side surface of the fifth lens is a convex surface.

5. The optical lens assembly according to claim 1, wherein,
an object-side surface of the sixth lens is a convex surface and an image-side surface of the sixth lens is a concave surface;
an object-side surface of the sixth lens is a convex surface and an image-side surface of the sixth lens is a convex surface; or
an object-side surface of the sixth lens is a concave surface and an image-side surface of the sixth lens is a convex surface.

6. The optical lens assembly according to claim 1, wherein the fourth lens and the fifth lens are cemented to form a cemented lens.

7. The optical lens assembly according to claim 1, wherein the first lens and the sixth lens have aspheric surfaces.

8. The optical lens assembly according to claim 1, wherein
TTL/F≤7;
TTL/H/FOV≤0.05;
D/H/FOV≤0.03; or
BFL/TTL≥0.05,
where TTL is a distance on the optical axis from a center of an object-side surface of the first lens to an image plane of the optical lens assembly, FOV is a maximal field-of-view of the optical lens assembly, D is a diameter of maximal aperture of an object-side surface of the first lens corresponding to the maximal field-of-view of the optical lens assembly, BFL is a distance on the optical axis from a center of an image-side surface of the sixth lens to the image plane of the optical lens assembly.

9. The optical lens assembly according to claim 1, wherein
arctan(1/K2)≥35;
arctan(1/K11)≤−4; or
arctan(1/K12)≤0,
wherein K2 is a lens edge slope of the image-side surface of the first lens corresponding to a maximal field-of-view of the optical lens assembly, K11 is a lens edge slope of an object-side surface of the sixth lens corresponding to a maximal field-of-view of the optical lens assembly, and K12 is a lens edge slope of an image-side surface of the sixth lens corresponding to a maximal field-of-view of the optical lens assembly.

10. The optical lens assembly according to claim 1, wherein
1≤F45/F≤13;
0.2≤|F4/F513;
1.0≤|F3/F|≤4;
−2.0≤F1/F≤−1.0;
R7/F≤−2; or

|F6/F|≥3.5,
wherein F45 is an effective focal length of a cemented lens formed by cementing the fourth lens and the fifth lens, F1 is an effective focal length of the first lens, F3 is an effective focal length of the third lens, F4 is an effective focal length of the fourth lens, F5 is an effective focal length of the fifth lens, F6 is an effective focal length of the sixth lens, R7 is a radius of curvature of an image-side surface of the third lens.

11. The optical lens assembly according to claim 1, wherein
−6.0≤R10/F≤−1.0;
0.6≤R3/R4;
0.2≤|R4/(|R3|+T2)|≤1.2;
T2/TTL≥0.15;
0.7≤(T₃₋₁₃)/TTL≤0.9;
0.04≤d23/TTL≤0.2;
0.3≤d8i/TTL; or

|SAG11/D11/2|≤0.22,
wherein R3 is a radius of curvature of the object-side surface of the second lens, R4 is a radius of curvature of the image-side surface of the second lens, R10 is a radius of curvature of an image-side surface of the fifth lens, TTL is a distance on the optical axis from a center of an object-side surface of the first lens to an image plane of the optical lens assembly, T2 is a center thickness of the second lens, T₃₋₁₃ is a distance on the optical axis from a center of the object-side surface of the second lens to a center of an image-side surface of an auxiliary lens located between the sixth lens and the image plane, d23 is a spacing distance on the optical axis from a center of the image-side surface of the second lens to a center of the object-side surface of the third lens, d8i is a distance on the optical axis from a center of an object-side surface of the fourth lens to the image plane, SAG11 is a sagittal height at a maximal aperture of an object-side surface of the sixth lens corresponding to a maximal field-of-view of the optical lens assembly, and D11 is a diameter of a maximal aperture of the object-side surface of the sixth lens corresponding to the maximal field-of-view of the optical lens assembly.

12. The optical lens assembly according to claim 1, wherein
0.3≤(H/2)/(F*tan(θ/2)≤1.6; or
(FOV×F)/H≥65,
wherein θ is a maximal field-of-view of the optical lens assembly with a radian as a unit, and FOV is a maximal field-of-view of the optical lens assembly.

13. The optical lens assembly according to claim 6, wherein
the fourth lens has a positive refractive power, and max{Tn/Tm}≤2, n=2, 3 or 4, and m=2, 3 or 4, where Tn is a center thickness of a n-th lens having a largest center thickness in the second lens, the third lens and the fourth lens, and Tm is a center thickness of an m-th lens having a smallest center thickness in the second lens, the third lens and the fourth lens;
the fourth lens has a negative refractive power, and max{Tn/Tm}≤2, n=2, 3 or 5, and m=2, 3 or 5, where Tn is a center thickness of a n-th lens having a largest center thickness in the second lens, the third lens and the fifth lens, and Tm is a center thickness of an m-th lens having a smallest center thickness in the second lens, the third lens and the fifth lens;
the fourth lens has a negative refractive power, and 1.2≤|F3/F5|≤2.8, wherein F3 is an effective focal length of the third lens, and F5 is an effective focal length of the fifth lens;
the fourth lens has a positive refractive power, and 1≤|F3/F4|≤3, wherein F3 is an effective focal length of the third lens, and F4 is an effective focal length of the fourth lens;
the fourth lens has a positive refractive power, and −2×10⁶≤(F3+F4)/(dn/dt(3)+dn/dt(4))≤−4×10⁵, wherein dn/dt(3) is a temperature coefficient of refractive index of the third lens, and dn/dt(4) is a temperature coefficient of refractive index of the fourth lens; or
the fourth lens has a negative refractive power, and −2×10⁶≤(F3+F5)/(dn/dt(3)+dn/dt(5))≤−4×10⁵, wherein dn/dt(5) is a temperature coefficient of refractive index of the fifth lens.

14. The optical lens assembly according to claim 1, wherein
0.5≤Nd1/Nd2≤1.5;
Vd4/Vd5≤5.3; or
FNO/F≥0.1,
wherein Nd1 is a refractive index of the first lens, Nd2 is a refractive index of the second lens, Vd4 is an abbe number of the fourth lens, Vd5 is an abbe number of the fifth lens, and FNO is an f-number of the optical lens assembly.

15. An optical lens assembly, comprising, sequentially from an object side to an image side along an optical axis:
a first lens, having a negative refractive power, an image-side surface of the first lens being a concave surface;
a second lens, having a refractive power, an object-side surface of the second lens being a concave surface, and an image-side surface of the second lens being a convex surface;
a third lens, having a positive refractive power, an object-side surface of the third lens being a convex surface, and an image-side surface of the third lens being a convex surface;
a fourth lens, having a refractive power, an object-side surface of the fourth lens being a convex surface;
a fifth lens, having a refractive power; and
a sixth lens, having a refractive power,
wherein 0.3≤(H/2)/(F*tan(θ/2)≤1.6,
θ is a radian of a maximal field-of-view of the optical lens assembly, F is a total effective focal length of the optical lens assembly, and H is an image height corresponding to the maximal field-of-view of the optical lens assembly.

16. The optical lens assembly according to claim 15, wherein an object-side surface of the first lens is a convex or concave surface.

17. The optical lens assembly according to claim 15, wherein an image-side surface of the fourth lens is a convex or concave surface.

18. The optical lens assembly according to claim 15, wherein,
an object-side surface of the fifth lens is a concave surface and an image-side surface of the fifth lens is a convex surface;
an object-side surface of the fifth lens is a concave surface and an image-side surface of the fifth lens is a concave surface; or
an object-side surface of the fifth lens is a convex surface and an image-side surface of the fifth lens is a convex surface.

19. The optical lens assembly according to claim 15, wherein,
an object-side surface of the sixth lens is a convex surface and an image-side surface of the sixth lens is a concave surface;
an object-side surface of the sixth lens is a convex surface and an image-side surface of the sixth lens is a convex surface; or
an object-side surface of the sixth lens is a concave surface and an image-side surface of the sixth lens is a convex surface.

20. The optical lens assembly according to claim 15, wherein the fourth lens and the fifth lens are cemented to form a cemented lens.

21. The optical lens assembly according to claim 15, wherein the first lens and the sixth lens have aspheric surfaces.

22. The optical lens assembly according to claim 15, wherein
TTL/F≤7;
TTL/H/FOV≤0.05;
D/H/FOV≤0.03; or
BFL/TTL≥0.05,
where TTL is a distance on the optical axis from a center of an object-side surface of the first lens to an image plane of the optical lens assembly, FOV is a maximal field-of-view of the optical lens assembly, D is a diameter of maximal aperture of an object-side surface of the first lens corresponding to the maximal field-of-view of the optical lens assembly, BFL is a distance on the optical axis from a center of an image-side surface of the sixth lens to the image plane of the optical lens assembly.

23. The optical lens assembly according to claim 15, wherein
arctan(1/K2)≥35;
arctan(1/K11)≤−4; or
arctan(1/K12)≤0,
wherein K2 is a lens edge slope of the image-side surface of the first lens corresponding to a maximal field-of-view of the optical lens assembly, K11 is a lens edge slope of an object-side surface of the sixth lens corresponding to a maximal field-of-view of the optical lens assembly, and K12 is a lens edge slope of an image-side surface of the sixth lens corresponding to a maximal field-of-view of the optical lens assembly.

24. The optical lens assembly according to claim 15, wherein
1≤F45/F≤13;
0.2≤|F4/F513;
1.0≤|F3/F|≤4;
−2.0≤F1/F≤−1.0;
R7/F≤−2; or

|F6/F|≥3.5,
wherein F45 is an effective focal length of a cemented lens formed by cementing the fourth lens and the fifth lens, F1 is an effective focal length of the first lens, F3 is an effective focal length of the third lens, F4 is an effective focal length of the fourth lens, F5 is an effective focal length of the fifth lens, F6 is an effective focal length of the sixth lens, R7 is a radius of curvature of an image-side surface of the third lens.

25. The optical lens assembly according to claim 15, wherein
−6.0≤R10/F≤−1.0;
0.6≤R3/R4;
0.2≤|R4/(|R3|+T2)|≤1.2;
T2/TTL≥0.15;
0.7≤(T₃₋₁₃)/TTL≤0.9;
0.04≤d23/TTL≤0.2;
0.3≤d8i/TTL; or

|SAG11/D11/2|≤0.22,
wherein R3 is a radius of curvature of the object-side surface of the second lens, R4 is a radius of curvature of the image-side surface of the second lens, R10 is a radius of curvature of an image-side surface of the fifth lens, TTL is a distance on the optical axis from a center of an object-side surface of the first lens to an image plane of the optical lens assembly, T2 is a center thickness of the second lens, T₃₋₁₃ is a distance on the optical axis from a center of the object-side surface of the second lens to a center of an image-side surface of an auxiliary lens located between the sixth lens and the image plane, d23 is a spacing distance on the optical axis from a center of the image-side surface of the second lens to a center of the object-side surface of the third lens, d8i is a distance on the optical axis from a center of an object-side surface of the fourth lens to the image plane, SAG11 is a sagittal height at a maximal aperture of an object-side surface of the sixth lens corresponding to a maximal field-of-view of the optical lens assembly, and D11 is a diameter of a maximal aperture of the object-side surface of the sixth lens corresponding to the maximal field-of-view of the optical lens assembly.

26. The optical lens assembly according to claim 15, wherein
(H−F×θ)/(F×θ)≤−0.1; or
(FOV×F)/H≥65,
wherein θ is a maximal field-of-view of the optical lens assembly with a radian as a unit, and FOV is a maximal field-of-view of the optical lens assembly.

27. The optical lens assembly according to claim 20, wherein
the fourth lens has a positive refractive power, and max{Tn/Tm}≤2, n=2, 3 or 4, and m=2, 3 or 4, where Tn is a center thickness of a n-th lens having a largest center thickness in the second lens, the third lens and the fourth lens, and Tm is a center thickness of an m-th lens having a smallest center thickness in the second lens, the third lens and the fourth lens;
the fourth lens has a negative refractive power, and max{Tn/Tm}≤2, n=2, 3 or 5, and m=2, 3 or 5, where Tn is a center thickness of a n-th lens having a largest center thickness in the second lens, the third lens and the fifth lens, and Tm is a center thickness of an m-th lens having a smallest center thickness in the second lens, the third lens and the fifth lens;
the fourth lens has a negative refractive power, and 1.2≤|F3/F5|≤2.8, wherein F3 is an effective focal length of the third lens, and F5 is an effective focal length of the fifth lens;
the fourth lens has a positive refractive power, and 1≤|F3/F4|≤3, wherein F3 is an effective focal length of the third lens, and F4 is an effective focal length of the fourth lens;
the fourth lens has a positive refractive power, and −2×10⁶≤(F3+F4)/(dn/dt(3)+dn/dt(4))≤−4×10⁵, wherein dn/dt(3) is a temperature coefficient of refractive index of the third lens, and dn/dt(4) is a temperature coefficient of refractive index of the fourth lens; or
the fourth lens has a negative refractive power, and −2×10⁶≤(F3+F5)/(dn/dt(3)+dn/dt(5))≤−4×10⁵, wherein dn/dt(5) is a temperature coefficient of refractive index of the fifth lens.

28. The optical lens assembly according to claim 15, wherein
0.5≤Nd1/Nd2≤1.5;
Vd4/Vd5≤5.3; or
FNO/F≥0.1,
wherein Nd1 is a refractive index of the first lens, Nd2 is a refractive index of the second lens, Vd4 is an abbe number of the fourth lens, Vd5 is an abbe number of the fifth lens, and FNO is an f-number of the optical lens assembly.

29. An electronic device, comprising:
an optical lens assembly; and
an imaging element used to convert an optical image formed by the optical lens assembly into an electrical signal,
wherein the optical lens assembly comprises, sequentially from an object side to an image side along an optical axis:
a first lens, having a negative refractive power, an image-side surface of the first lens being a concave surface;
a second lens, having a refractive power, an object-side surface of the second lens being a concave surface, and an image-side surface of the second lens being a convex surface;
a third lens, having a positive refractive power, an object-side surface of the third lens being a convex surface, and an image-side surface of the third lens being a convex surface;
a fourth lens, having a refractive power, an object-side surface of the fourth lens being a convex surface;
a fifth lens, having a refractive power; and
a sixth lens, having a refractive power,
wherein (H−F×θ)/(F×θ)≤−0.1,
θ is a radian of a maximal field-of-view of the optical lens assembly, F is a total effective focal length of the optical lens assembly, and H is an image height corresponding to the maximal field-of-view of the optical lens assembly.
